(19) United States
(12) Patent Application Publication
(10) Pub. No.: US 2026/0122407 A1
(43) Pub. Date: Apr. 30, 2026

(54) COMPACT SPEAKER

(71) Applicant: Sonos, Inc., Goleta, CA (US)

(72) Inventors: Timothy Ruben Scheek, Rotterdam (NL); Bridget Hunter-Jones, Boston, MA (US); Victoria Lynne Birkenback, Campbell, CA (US); Anaïs Choi Sarrazin, San Francisco, CA (US)

(21) Appl. No.: 19/374,122

(22) Filed: Oct. 30, 2025

Related U.S. Application Data
(60) Provisional application No. 63/714,588, filed on Oct. 31, 2024.

(51) Int. Cl. H04R 1/24; G06F 3/16; H04R 1/02; H04R 7/04; H04R 7/16; H04R 9/02; H04R 9/06; H04R 27/00

(52) U.S. Cl. CPC H04R 1/24; G06F 3/167; H04R 1/02; H04R 7/04; H04R 7/16; H04R 9/025; H04R 9/06; H04R 27/00; H04R 2227/005

(57) ABSTRACT

An example speaker assembly includes a housing having a front face, a rear face, and a side wall, the housing including one or more acoustic ports formed in the side wall, and a transducer at least partially disposed within the housing. The transducer includes first and second membranes arranged coaxially about a transducer axis in an opposed relation to each other and configured to move towards and away from the front face along the transducer axis, wherein the transducer axis is parallel to the side wall, and a driver assembly configured to drive the first and second membranes to produce acoustic energy. The speaker assembly is configured to direct first acoustic energy from the first membrane to an exterior of the housing via the front face, and to direct second acoustic energy from the second membrane to the exterior of the housing via the one or more acoustic ports.

### CROSS-REFERENCE TO RELATED APPLICATION

This application claims priority under 35 U.S.C. § 119(e) to U.S. Provisional Application No. 63/714,588 titled “COMPACT SPEAKER” and filed on Oct. 31, 2024, which is hereby incorporated herein by reference in its entirety.

### FIELD OF THE DISCLOSURE

The present disclosure relates to consumer goods and, more particularly, to media playback or some aspect thereof.

### BACKGROUND

Wireless home sound systems can allow people to experience music from many sources via one or more networked playback devices. Through a program installed on a control device (e.g., smartphone, tablet, computer, or other device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Aspects and advantages of the technology disclosed herein may be better understood with regard to the following description, appended claims, and accompanying drawings, as listed below.

FIG. 1 is a plan view of an environment having a media playback system configured in accordance with aspects of the disclosed technology.

FIG. 2A is a schematic diagram of the media playback system of FIG. 1 and one or more networks, according to aspects of the disclosed technology.

FIG. 2B is a sequence diagram of a media playback system in accordance with aspects of the disclosed technology.

FIG. 3A is a diagram of a playback device in accordance with aspects of the disclosed technology.

FIG. 3B is a block diagram of a playback device in accordance with aspects of the disclosed technology.

FIG. 3C is a diagram of a user interface for a playback device in accordance with aspects of the disclosed technology.

FIG. 3D is a block diagram of voice processing circuitry that can be used in a playback device, according to aspects of the disclosed technology.

FIG. 4 is a partial block diagram of an example of a control device, in accordance with aspects of the disclosed technology.

FIGS. 5A-D are schematic diagrams of media playback system configurations, in accordance with aspects of the disclosed technology.

FIG. 6A is a perspective view of one example of a force-cancelling speaker assembly, in accordance with aspects of the disclosed technology.

FIG. 6B is a side view of the force-cancelling speaker assembly of FIG. 6A.

FIG. 7 is a diagram of an example of a speaker assembly including a force-cancelling transducer in accordance with aspects of the disclosed technology.

FIG. 8 is diagram of an example of the speaker assembly of FIG. 7 according to aspects of the disclosed technology.

FIG. 9A is a diagram of an example of the speaker assembly of FIG. 7 according to aspects of the disclosed technology.

FIG. 9B is a diagram illustrating another example of a housing for the speaker assembly of FIG. 9A, according to aspects of the disclosed technology.

FIG. 10A is a diagram illustrating a perspective view of an example of a housing of the speaker assembly of FIG. 7, according to aspects of the disclosed technology.

FIG. 10B is a perspective view illustrating an example of a speaker assembly with a removable portion of the housing of FIG. 10A removed, in accordance with aspects of the disclosed technology.

FIG. 11 is a diagram showing a speaker assembly attached to a device, in accordance with aspects of the disclosed technology.

The drawings are for the purpose of illustrating examples; however, it will be understood that variations, including different and/or additional aspects and arrangements thereof, are possible, and that the technology disclosed herein is not limited to the arrangements and/or instrumentality shown in the drawings.

### DETAILED DESCRIPTION

### I. Overview

Examples described herein relate to providing a playback device with a compact form factor that can deliver high-quality sound experience, with significant acoustic amplitude and bass, equivalent or similar to that of much larger devices. There are numerous instances in which it may be desirable for a user to have a highly portable playback device with a very compact form factor. For example, to allow the user to easily carry the playback device with them without it adding significant weight or taking up much space. However, some portable devices, due to their relatively small form factor, offer only limited sound output, particularly often lacking in acoustic bass or volume (loudness) capability. Accordingly, achieving a satisfactory combination of portability (e.g., size, weight, etc.) and output sound quality can be challenging. Examples described herein leverage a “force-canceling” transducer configuration, in which the transducer comprises two opposing membranes each driven by respective motors to generate acoustic energy in opposing directions, to achieve greater sound output from a small volume. Certain examples also have an ultra-small form factor (e.g., smaller than a standard deck of cards), optionally along with an attachment mechanism for attaching to another device (e.g., a mobile phone). Furthermore, to accommodate both the force-cancelling transducer configuration and placement of the playback device against a surface that may be substantially parallel to the membranes of the transducer, examples provide a compact housing that includes one or more acoustic ports configured to redirect acoustic energy from at least one of the transducer membranes away from the surface. Thus, examples described herein may provide a playback device offering enhanced portability and convenience, while retaining the ability to provide a high-quality sound experience for the user.

In some examples, a speaker assembly comprises a housing and a transducer at least partially disposed within the housing. The housing has a front face, a rear face, and at least one side wall having a first edge coupled to the front face along a perimeter of the front face, the at least one side wall extending perpendicularly to the front face. The housing includes one or more acoustic ports formed in the at least one side wall. The one or more acoustic ports may be positioned at a second edge of the side wall opposite to the first edge. In some examples, the transducer comprises a first membrane and a second membrane arranged coaxially about a transducer axis in an opposed relation to each other and configured to move towards and away from the front face along the transducer axis. The transducer axis is parallel to the at least one side wall. The transducer further comprises a driver assembly configured to drive the first and second membranes to produce acoustic energy. In some examples, the speaker assembly is configured to direct first acoustic energy from the first membrane to an exterior of the housing via the front face, and to direct second acoustic energy from the second membrane to the exterior of the housing via the one or more acoustic ports. The speaker assembly can be, or can be part of, a portable playback device, for example.

These and other examples and aspects described herein improve upon earlier-developed systems and methods including, for example, systems and methods disclosed and described in the following patents and/or patent applications.

U.S. Pat. No. 8,234,395 titled, “System and Method for Synchronizing Operations Among a Plurality of Independently Clocked Digital Data Processing Devices,” filed on Apr. 1, 2004 and issued on Jul. 31, 2012 (“Millington '395) describes, among other features, examples of synchronizing audio playback among a plurality of playback devices or groups of playback devices.

U.S. Pat. No. 8,483,853 titled “Controlling and Manipulating Groupings in a Multi-zone Media System,” filed on Sep. 11, 2007 and issued on Jul. 9, 2013 (“Lambourne '853”) describes, among other features, techniques of controlling a plurality of multimedia players in groups. According to Lambourne '853, a user can group some of the players according to a theme or scene, where each of the players is located in a zone. Lambourne '853 discloses that when the scene is activated, the players in the scene react in a synchronized manner. For example, the players in the scene can all be caused to play a multimedia source or music in a playlist, wherein the multimedia source may be located anywhere on a network.

U.S. Pat. No. 8,788,080 titled “Multi-channel Pairing in a Media System” filed on Apr. 8, 2011 and issued on Jul. 22, 2014 (Kallai '080”) describes, among other features, techniques for grouping, consolidating, and/or pairing two or more playback devices together to create or enhance multi-channel audio reproduction, such as stereo, surround sound, or some other multi-channel reproduction.

U.S. Pat. No. 10,142,726 titled “Noise Reduction for High-Airflow Audio Transducers” filed on Jan. 31, 2017 and issued on Nov. 27, 2018 (Oishi '726) describes, among other features, techniques for reducing turbulence noise from an audio transducer mounted within an interior housing of a playback device. Oishi '726 describes a playback device including an enclosure having a first interior volume and a second interior volume, the playback device further including a speaker mounted within an interior of the enclosure. According to Oishi '726, the speaker includes a diaphragm dividing the first interior volume and the second interior volume, and the speaker is moveable along an axis to generate sound. According to Oishi '726, the playback device may also include first and second speaker vents that provide airflow between the first interior volume and an exterior of the enclosure. Oishi '726 describes that the first speaker vent directs airflow in a first direction and that the second speaker vent directs airflow in a second direction.

U.S. Pat. No. 10,499,146 titled “Voice Control of a Media Playback System,” filed on Feb. 21, 2017 and issued on Dec. 3, 2019 (“Lang '146”) discloses voice control and related features and functionality for media playback devices, networked microphone devices, microphone-equipped media playback devices, and speaker-equipped networked microphone devices. Lang '146 describes, among other features, designating and managing default networked devices, audio response playback, room-corrected voice detection, content mixing, music service selection, metadata exchange between networked playback systems and networked microphone systems, handling loss of pairing between networked devices, actions based on user identification, and other voice control of networked devices.

U.S. Pat. No. 10,712,997 titled “Room Association Based on Name,” filed on Aug. 21, 2017 and issued on Jul. 14, 2020 (“Wilberding '997”) describes, among other features, using playback device attributes by a controller application to control one or more playback devices in a media playback system. According to Wilberding '997, the playback device attributes can include one or more of (i) a player name for the playback device, (ii) a player type of the playback device, (iii) a player icon for the playback device, (iv) a player configuration for the playback device, (v) a zone name for a zone associated with the playback device (e.g., the “downstairs zone” or “bedroom zone”), (vi) a session name for a session associated with the playback device, (vii) a room name where the playback device is located, (viii) a room type where the playback device is located, or (ix) a name of an area where the playback device is located (e.g., “downstairs” or “patio”). According to Wilberding '997, the controller application can be installed on a control device that may present a graphical user interface to facilitate user access and control of the media playback system, optionally using one or more of the playback device attributes.

U.S. Pat. No. 11,166,107 titled “Speaker Unit with a Speaker Frame and Two Opposing Sound Producing Membranes” filed on Nov. 4, 2020 and issued on Nov. 2, 2021 (“Scheek '107”) describes, among other features, a compact speaker unit that provides a linear response characteristic. In particular, Scheek '107 describes a loudspeaker unit having an improved compactness of architecture using a dual membrane driver architecture, while keeping the membrane movement as linear as possible, at least in part through the use of sealing edge suspensions and spider arm suspensions coupled to the membranes.

U.S. Pat. No. 11,297,415 titled “Low Profile Loudspeaker Device” having an international filing date of Oct. 26, 2018 and issued on Apr. 5, 2022 (“Scheek '415”) describes, among other features, a loudspeaker device having first and second diaphragms arranged co-axially in an opposed relation to one another to cancel mechanical vibrations. According to Scheek '415, in some examples, each diaphragm has multiple voice coils, with the voice coils of the first and second diaphragms being arranged in the same plane to reduce the height of the loudspeaker device.

U.S. Patent Publication No. 2020/0344554 titled “Distributed Transducer Suspension Cones” and having an international filing date of Apr. 24, 2018 (Scheek '4554) describes, among other features, speaker assemblies having two opposite directed diaphragms, and two speaker drivers, each having at least one magnetic driver for driving the two opposite directed diaphragms in operation.

U.S. Patent Publication No. 2021/0099736 titled “Systems and Methods for Playback Device Management” and filed on Jan. 28, 2020 (Soto '9736) describes, among other features, examples of techniques for localizing playback devices based on RSSI measurements. For example, Soto '9736 discloses localization techniques that involve measuring and normalizing signals between a portable device and reference devices (e.g., speakers, network devices, controllers, etc.) in a media playback system to estimate, for each reference device, a likelihood that the portable device is located near the reference device. According to Soto '9736, an example of a localization method includes measuring a first signal pattern for wireless signals between several devices, measuring a second signal pattern for the wireless signals after measuring the first signal pattern between the several devices, and determining an updated state of the system based on a difference between the second signal pattern and the first signal pattern.

U.S. Patent Publication No. 2022/0066008 titled “Ultrasonic Transmission for Presence Detection” and filed on Aug. 30, 2021 (Jones '6008) describes, among other features, examples of playback devices equipped with ultrasonic presence detection. According to Jones '6008, a receiving playback device can detect (e.g., using a microphone) audio signals that have been transmitted/output by one or more other playback devices, and use those detected audio signals to detect the presence of nearby playback devices. According to Jones '6008, the audio signals are unique to each playback device within a playback system and, as such, can be analyzed to identify the one or more playback devices and subsequently determine which playback device is nearest to the receiving device.

U.S. Patent Publication No. 2023/0276176 titled “Speaker Unit” and having an international filing date of Jul. 29, 2021 (“Scheek '6176”) describes, among other features, a speaker unit having a structure and mutual element orientation allowing to provide a self-balancing, more space efficient speaker unit for dual membrane units which have air displacement direction restrictions. According to Scheek '6176, a speaker unit includes first and second membranes arranged in opposite configuration in a speaker frame, wherein the secondary acoustic radiation direction is opposite to the major acoustic radiation directions, the first and second membranes being coaxially aligned along the major and secondary acoustic radiation directions. Scheek '6176 describes that in certain examples, the speaker unit includes two drive units that are positioned coaxial to each other at the same height in the speaker frame and laterally displaced from the membranes in a side-by-side arrangement therewith. According to Scheek '6176, the speaker unit may further comprise an acoustic duct providing a closed acoustic channel from the second membrane in the secondary acoustic radiation direction to a secondary surface of the speaker unit, the secondary surface being located in a same plane as the major plane of the speaker unit.

International Patent Publication No. WO 2023/060009 titled “Speaker Device” and having an international filing date of Sep. 29, 2022 (Scheek '0009) describes, among other features, a speaker device including a first diaphragm, an opposing second diaphragm, and a frame having a first frame part on which the first diaphragm is mounted and an opposing second frame part on which the second diaphragm is mounted. Scheek '0009 discloses that a first speaker driver drives the first diaphragm and a second speaker driver drives the second diaphragm. Scheek '0009 further discloses various shapes and configurations of the first and second diaphragms.

Each of U.S. Pat. Nos. 8,234,395, 8,483,853, 8,788,080, 10,142,726, 10,499,146, 10,712,997, 11,166,107, and 11,297,415, U.S. Patent Publication Nos. 2020/0344554, 2021/0099736, 2022/0066008, and 2023/0276176, and International Patent Publication WO 2023/060009 is hereby incorporated herein by reference in its entirety for all purposes.

None of the aforementioned earlier-filed applications/patents, individually or in combination, disclose the particular combinations of features and functions shown, described, and claimed herein that relate to speaker assemblies and/or playback devices that (i) have a housing that includes one or more acoustic ports formed in at least one side wall of the housing and a force-cancelling transducer disposed within the housing, wherein the speaker assembly is configured to direct first acoustic energy from the first membrane to an exterior of the housing via a front face of the housing, and to direct second acoustic energy from the second membrane to the exterior of the housing via the one or more acoustic ports, and/or (ii) include multiple additional transducers disposed within the housing and arranged about the force-cancelling transducer, the speaker assemblies and/or playback devices being configured to alter playback of audio content via the multiple additional transducers based on an orientation or placement of the device; and/or associated methods of operating such speaker assemblies and/or playback devices and media playback systems in which they are used.

Some examples described herein may refer to functions performed by actors such as users and/or other individuals. Such references are for the purposes of explanation only. No claim should be interpreted to require action by any particular actor unless explicitly required by the language of the claim.

In the Figures, identical reference numbers identify generally similar, and/or identical, elements. Many of the details, dimensions, angles, and/or other attributes shown in the Figures are merely illustrative of particular examples of the disclosed technology. Accordingly, other examples can have other details, dimensions, angles, and/or attributes without departing from the scope of the disclosure. In addition, further examples of the disclosed technologies can be practiced without several of the details described below.

### II. Example Operating Environment

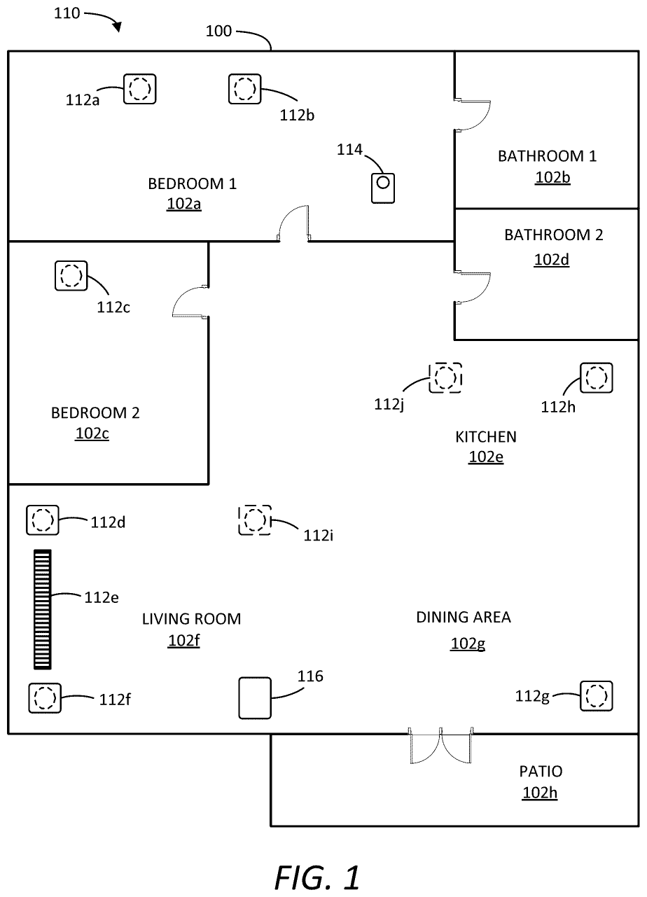

FIG. 1 is a plan (top) view of an environment 100 (e.g., a house) in which a media playback system 110 is installed. The media playback system 110 comprises one or more playback devices 112 (identified individually as playback devices 112a-j) and at least one control device 114. Examples of the playback devices 112 and control device 114 are described further below.

In the illustrated example of FIG. 1, the environment 100 comprises a household having several rooms and/or spaces, including a first bedroom 102a (“Bedroom 1”), a first bathroom 102b (“Bathroom 1”), a second bedroom 102c (“Bedroom 2”), a second bathroom 102d (“Bathroom 2”), a kitchen 102e, a living room 102f, a dining area 102g, and an outdoor patio 102h. Numerous other layouts and/or configurations of the environment 100 are possible, and the example illustrated in FIG. 1 is intended for the purpose of explanation only. Further, while certain examples are described below in the context of a home environment, the technologies described herein may be implemented in other types of environments. For example, the media playback system 110 can be implemented in one or more commercial settings (e.g., a restaurant, mall, airport, hotel, a retail or other store, etc.), one or more vehicles (e.g., a sports utility vehicle, bus, car, a ship, a boat, an airplane, etc.), multiple environments (e.g., a combination of home and vehicle environments), and/or another suitable environment where audio playback may be desirable.

As used herein the term “playback device” can generally refer to a network device configured to receive, process, and output data of a media playback system. For example, a playback device can be a network device that receives and processes audio content. In some examples, a playback device 112 includes one or more transducers or speakers powered by one or more amplifiers, as described further below. As used herein, the terms “transducer” or “speaker” refer generally to an electroacoustic transducer that converts an electrical audio signal into a corresponding sound. In other examples, however, a playback device includes one of (or neither of) the speaker(s) and/or the amplifier(s). For instance, a playback device 112 can comprise one or more amplifiers configured to drive one or more speakers external to the playback device via a corresponding wire or cable. In some examples, a playback device 112 includes one or more microphones and associated electronics configured for audio detection, as described further below. A playback device 112 that is configured for audio detection may be referred to in some instances as a network microphone device (NMD) or NMD-enabled playback device.

The term “control device” can generally refer to a network device configured to perform functions relevant to facilitating user access, control, and/or configuration of the media playback system 110. For example, the control device 114 can be configured to receive user input related to the media playback system 110 and, in response, cause one or more devices in the media playback system 110 to perform one or more actions or operations corresponding to the user input. In some examples, the control device 114 is a computing device (e.g., a computer, tablet, mobile phone, dedicated system controller, etc.) on which media playback system controller application software is installed. In some examples, the control device 114 is a user device, which may be a computing device having a human-accessible interface, such as a touch screen, voice-responsive interface, or other user-facing interface. Examples of a user device include a mobile phone with touch screen, tablet, personal computer, laptop computer, or dedicated system controller with a user interface. In some examples, the control device 114 is integrated into another device in the media playback system 110 (e.g., one or more of the playback devices 112), and/or another suitable device configured to communicate over a network (e.g., a television, automobile audio head unit, an internet of things (IoT) device, etc.). The control device 114 includes electronics configured to allow communication with one or more of the playback devices 112. In some examples, the control device 114 includes a display screen configured to display a graphical user interface through which a user can configure the media playback system 110 and/or control various functionality or operations of the media playback system 110, as described further below.

Some or all of the playback devices 112 are configured to receive audio signals or data from one or more media sources (e.g., one or more remote servers, one or more local devices, etc.) and to play back the received audio signals or data as sound. In some examples, one or more of the playback devices 112 are configured to receive spoken word commands, as described further below. The control device 114 is configured to receive user input and to control at least certain aspects of the media playback system 110 in response to the user input. For example, in response to the received spoken word commands and/or user input, the media playback system 110 can play back audio via one or more of the playback devices 112. In certain examples, the playback devices 112 are configured to commence playback of media content in response to a trigger condition. For instance, one or more of the playback devices 112 can be configured to play back a morning playlist upon detection of an associated trigger condition (e.g., presence of a user in the kitchen 102e at a certain time of day, etc.). In some examples, the media playback system 110 is configured to play back audio from a first playback device (e.g., the playback device 112a) in synchrony with a second playback device (e.g., the playback device 112b), as described in more detail below.

In some examples, one or more of the playback devices 112 (e.g., playback devices 112i and 112j in the example of FIG. 1) are portable playback devices, while others may be stationary playback devices. For example, the portable playback devices 112i and 112j may include an internal power source (e.g., a rechargeable battery) that allows the playback device to operate without being physically connected to a mains electrical outlet or the like. In this regard, such a playback device may be referred to herein as a “portable playback device.” On the other hand, playback devices that are configured to rely on power from a mains electrical outlet or the like (such as the playback device 112e, for example) may be referred to herein as “stationary playback devices,” although such devices may in fact be moved around the environment 100. In practice, a person might often take a portable playback device to and from the environment 100, or to and from various locations within the environment 100, while the one or more stationary playback devices are rarely moved.

In some examples, the media playback system 110 includes a docking station (or charging station) 116 for charging any portable playback devices (e.g., the playback devices 112i, 112j). Accordingly, the portable playback devices 112i, 112j may comprise the docking station 116 and/or an interface configured to interact with the docking station 116. Each portable playback device (e.g., playback devices 112i and 112j) may have a dedicated docking station 116. In other examples, two or more portable playback devices 112i, 112j may share a common docking station 116.

Any one or more of the playback devices 112 may be stand-alone devices or may be integral to another device or component such as a television, an LP turntable, a lighting fixture, or some other device for indoor and/or outdoor use.

The media playback system 110 can comprise one or more playback spaces, some of which may correspond to rooms, portions of rooms, or combinations thereof, in the environment 100. The media playback system 110 can be established with one or more initial playback spaces, after which additional spaces may be added, and/or spaces may be removed, to form various configurations. Each playback space may be given a name, for example, according to a different room, combination of rooms, or other region within the environment 100, such as the first bedroom 102a, the dining area 102g, or living room 102f. In some aspects, a single playback space may include multiple rooms. In other aspects, a single room or portion of a room/region within the environment 100 may include multiple playback spaces. Each playback space can include one or more playback devices 112 that are grouped together, as described further below. In some examples, playback devices 112 in one or more playback spaces in the environment 100 can play the same or different audio content. In some examples, the playback devices 112 in two or more playback spaces can be configured to play the same audio content in synchrony with one another, such that a user perceives that the audio content is being played seamlessly (or at least substantially seamlessly) while moving around the environment 100.

### a. Example Media Playback System

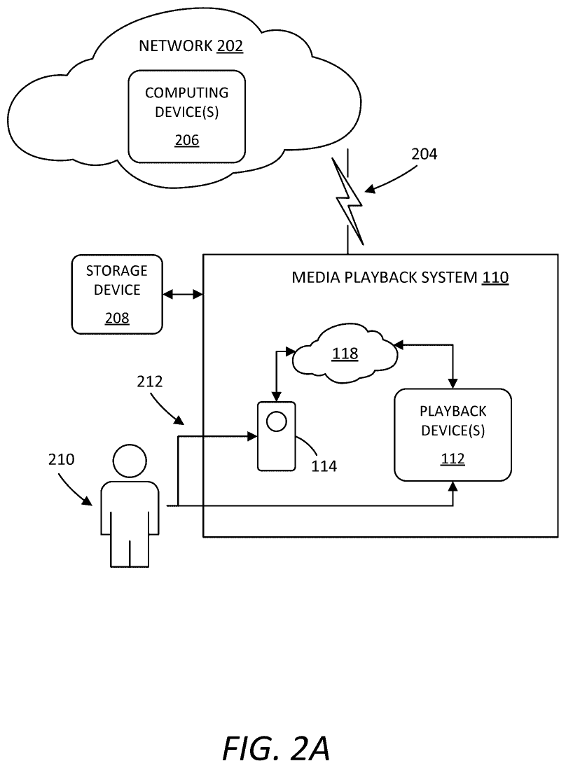

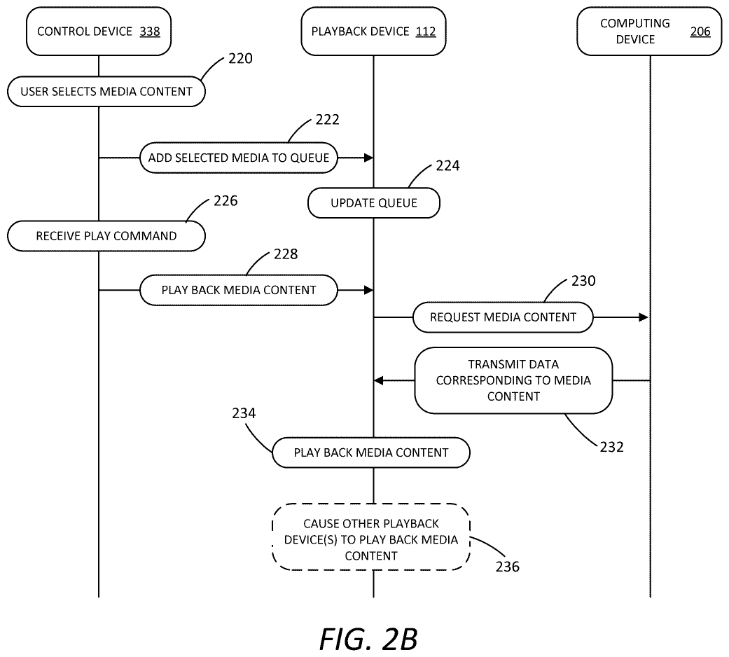

FIG. 2A is a schematic diagram of the media playback system 110 and a cloud network 202, according to certain examples. One or more communication links 204 (referred to herein as “the communication links”) communicatively couple the media playback system 110 and the cloud network 202. The communication links 204 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks, etc.). The cloud network 202 may deliver media content (e.g., audio content, video content, photographs, social media content, etc.) to the media playback system 110 in response to a request transmitted from the media playback system 110 via the communication links 204. In some examples, the cloud network 202 is further configured to receive data (e.g., voice input data and/or other data) from the media playback system 110 and correspondingly transmit commands and/or media content to the media playback system 110.

The cloud network 202 comprises one or more computing devices 206 (referred to herein as “the computing devices”). The computing devices 206 can comprise one or more individual computers or servers, such as, for example, a media streaming service server storing audio and/or other media content, a voice service server, a social media server, a media playback system control server, etc. In some examples, the computing devices 206 comprise one or more parts of a single computer or server. In some examples, the computing devices 206 comprise one or computers, servers, and/or other circuitry. Moreover, while the cloud network 202 is described above in the context of a single cloud network, in some examples the cloud network 202 comprises a plurality of cloud networks comprising communicatively coupled computing devices 206.

The media playback system 110 is configured to receive media content from the cloud network 202 via the communication links 204. The received media content can comprise, for example, a Uniform Resource Identifier (URI) and/or a Uniform Resource Locator (URL). For example, the media playback system 110 can stream, download, or otherwise obtain data via a URI or a URL corresponding to the received media content. A network 118 communicatively couples the communication links 204 and at least some of the devices (e.g., one or more of the playback devices 112 and/or the control device 114) of the media playback system 110. The network 118 can include, for example, a wireless network (e.g., a WI-FI network, a BLUETOOTH network, a Z-WAVE network, a ZIGBEE network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11g, 802.11n, 802.11ac, 802.11ad, 802.11af, 802.11ah, 802.11ai, 802.11aj, 802.11aq, 802.11ax, 802.11ay, 802.15, etc. transmitted at one or more frequencies in the 2.4 Gigahertz (GHz), 5 GHz, 6 GHz, and/or another suitable, frequency band.

In some examples, the network 118 comprises a dedicated communication network that the media playback system 110 uses to transmit messages between individual devices and/or to transmit media content to and from media content sources (e.g., the computing devices 206). In certain examples, the network 118 is configured to be accessible only to devices in the media playback system 110, thereby reducing interference and competition with other household devices. In other examples, however, the network 118 comprises an existing household or commercial facility communication network (e.g., a household or commercial facility WI-FI network). In some examples, the communication links 204 and the network 118 comprise one or more of the same networks. For example, the communication links 204 and the network 118 may comprise a telecommunications network (e.g., an LTE network, a 5G network, etc.). Moreover, in some examples, the media playback system 110 is implemented without the network 118, and devices comprising the media playback system 110 can communicate with each other, for example, via one or more direct connections, PANs, telecommunication networks, and/or other suitable communication links. In some examples, the network 118 is (or includes) a LAN implemented within, or partially within, the environment 100.

In some examples, audio content sources may be regularly added or removed from the media playback system 110. In some examples, the media playback system 110 performs an indexing of media items when one or more media content sources are updated, added to, and/or removed from the media playback system 110. The media playback system 110 can scan identifiable media items in some or all folders and/or directories accessible to the playback devices 112 and generate or update a media content database comprising metadata (e.g., title, artist, album, track length, etc.) and other associated information (e.g., URIs, URLs, etc.) for each identifiable media item found. For example, the media content database may be stored on one or more of the playback devices 112, a local storage device 208 (that may be part of, or communicatively coupled to, one or more devices in the media playback system 110), and/or the control device 114. In some examples, the local storage device 208 is part of a computing device that is accessible to the media playback system 110 (e.g., via the network 118 or via another wired or wireless communication link).

In some examples, one or more devices in the media playback system 110 can be configured to receive input or control signals 212 from a user 210. These control signals 212 can be detected via a user interface on the control device 114 and/or on one or more of the playback devices 112, as described further below. In some examples, one or more of the playback devices 112 include a microphone and other circuitry configured to receive at least some of the control signals 212 as voice input from the user 210, as described further below. In some examples, the control device 114 is configured to receive at least some of the control signals 212 as voice input from the user 210.

FIG. 2B is a sequence diagram illustrating data exchanges between devices of the media playback system 110, according to certain examples.

At step 220, the media playback system 110 receives an indication of selected media content (e.g., one or more songs, albums, playlists, podcasts, videos, stations) via the control device 114. The selected media content can comprise, for example, media items stored locally on one or more devices (e.g., the storage device 208) connected to the media playback system 110 and/or media items stored on one or more media services (hosted by one or more of the computing devices 206). In response to receiving the indication of the selected media content, the control device 114 transmits a message 222 to the playback device 112 to add the selected media content to a playback queue on the playback device 112.

At step 224, the playback device 112 receives the message 222 and adds the selected media content to the playback queue for playback.

At step 226, the control device 114 receives input corresponding to a command to play back the selected media content. In response to receiving the input corresponding to the command to play back the selected media content, the control device 114 transmits a message 228 to the playback device 112 causing the playback device 112 to play back the selected media content. In response to receiving the message 228, the playback device 112 transmits a message 230 to at least one of the computing devices 206 requesting the selected media content. The message may specify, for example, a URL or a URI corresponding to the selected media content. The computing device 206, in response to receiving the message 230, transmits a message or stream 232 comprising data (e.g., audio data, video data) corresponding to the requested media content.

At step 234, the playback device 112 receives the message or stream 232 with the data corresponding to the requested media content and plays back the associated media content.

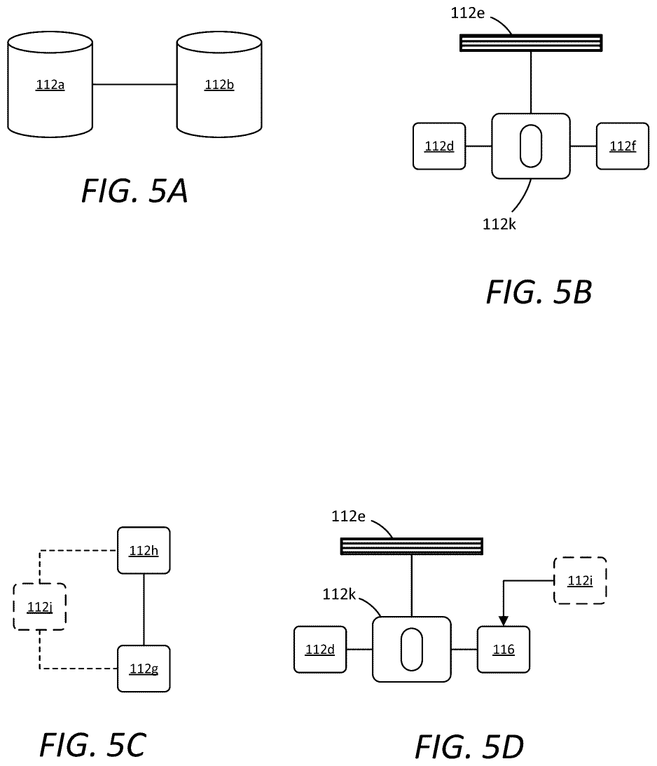

At step 236, the playback device 112 optionally causes one or more other devices to play back the selected media content. In some examples, the playback device 112 is a member device of a group comprising two or more playback devices, as described below with reference to FIGS. 5A-CD. In such an example, the playback device 112 can receive the selected media content and transmit all or a portion of the media content to other playback devices in the group. The other one or more devices in the group can receive the selected media content from the computing devices 206 (or from the playback device 112), and begin playback of the selected media content in response to a message from the playback device 112 such that all of the devices in the group play back the selected media content in synchrony. Additional details regarding audio playback synchronization among playback devices and/or zones can be found, for example, in Millington '395 referenced above.

### b. Example Playback Devices

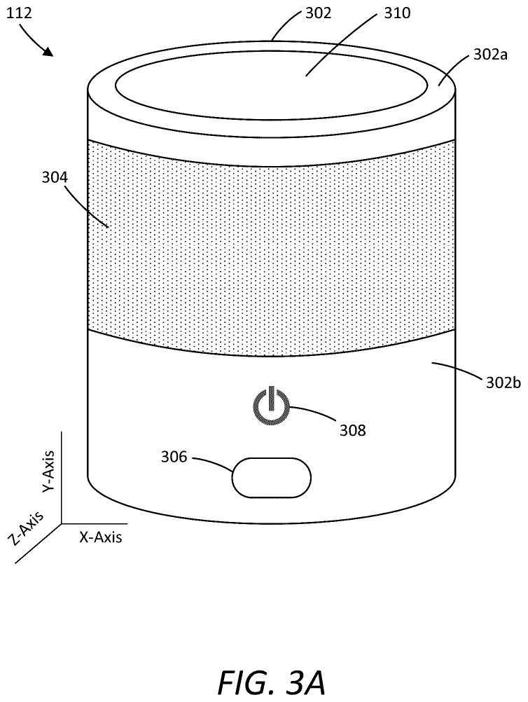

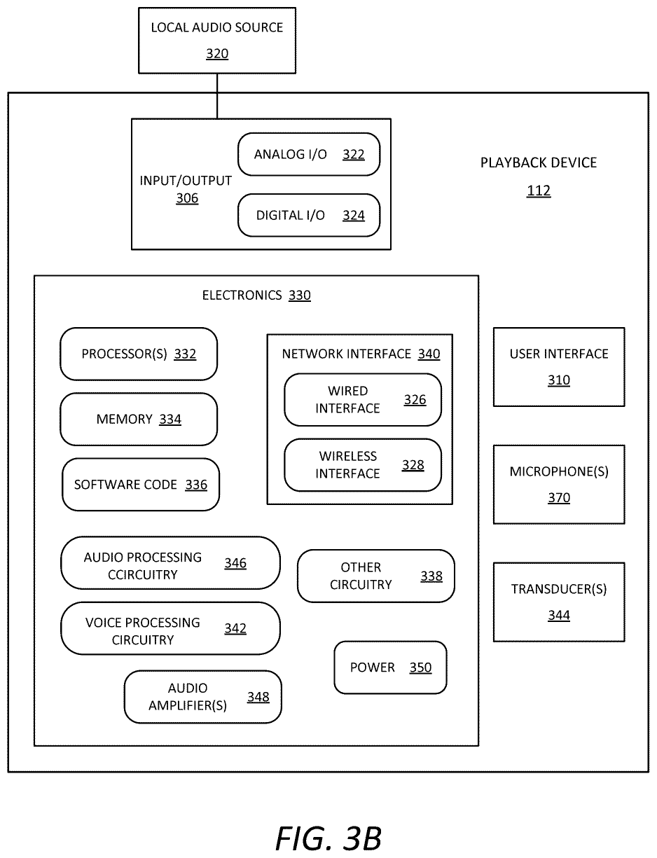

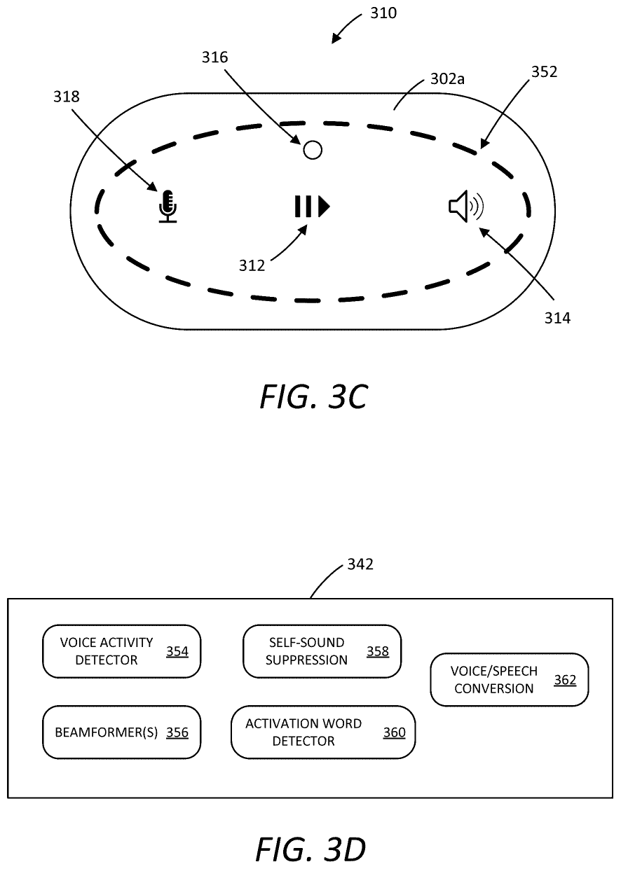

FIG. 3A is a diagram illustrating a playback device 112 according to certain examples. The playback device 112 includes a housing 302 that houses a plurality of components, as described further below. The housing 302 includes a plurality of surfaces, such as a top surface 302a and one or more side surfaces 302b. In the illustrated example of FIG. 3A, the housing 302 has a cylindrical shape; however, in other examples, the housing 302 may have a different shape, such as rectangular, square, trapezoidal, or other shape. Furthermore, in various examples the housing 302 may have an aspect ratio other than as illustrated in FIG. 3A. For example, the housing 302 may have an elongated form factor (e.g., longer in the X dimension than in the Y or Z dimensions). In other examples, the playback device 112 may comprise wired or wireless headphones (e.g., over-the-ear headphones, on-ear headphones, in-ear earphones, etc.), and thus the housing 302 may comprise two or more housings or housing components (e.g., earcups, earbuds, and/or a headband) that may be separate or coupled together. Numerous variations are envisioned and intended to be part of this disclosure.

In some examples, the housing 302 includes a grille 304. In the example of FIG. 3A, the grille 304 is shown extending over a portion of the side surface 302b; however, in other examples the grille 304 may cover an entire region of, or portion of, one or more side surfaces of the housing 302 and/or the top surface 302a of the housing 302. The grille 304 may include perforations, ports, or other openings, to allow sound (e.g., acoustic energy) from one or more transducers housed within the housing 302 to be emitted from the playback device 112.

In some examples, the playback device 112 includes an input/output 306 configured to allow the playback device 112 to be connected to and/or communicate with another device, as described further below. In some examples, the playback device 112 can receive operating power via the input/output 306 (e.g., through connection to a mains outlet or other electrical power supply). Although the input/output 306 is illustrated in FIG. 3A as a single object, the input/output 306 may include multiple ports, interfaces, connectors, cables, antennas, and/or other components, as described further below.

The playback device 112 may further include a power button (or switch) 308 configured to allow a user to turn the playback device 112 on and off. In some examples, the power button 308 includes a light or other visual indicator that indicates whether the playback device 112 is on, off, or in some other state (e.g., on, but in a sleep state). In the example illustrated in FIG. 3A, the power button and the input/output 306 are illustrated as located on the side surface 302b of the housing 302; however, in other examples, the power button 308 may be located on a different surface of the housing than the input/output 306.

In some examples, the playback device 112 includes a user interface 310 configured to allow a user to interact with, and optionally control various functionality of, the playback device 112, as described further below. In the example illustrated in FIG. 3A, the user interface 310 is shown on the top surface 302a of the housing 302; however, in other examples, the user interface 310 may include one or more components located on other surfaces of the housing 302. For example, the power button 308 may be part of the user interface 310.

Turning now to FIG. 3B, illustrated is a block diagram of the playback device 112 according to certain examples. In the illustrated example, the playback device 112 includes the input/output 306, the user interface 310, and electronics 330. The playback device 112 may optionally include one or more microphones 370 (e.g., a single microphone, a plurality of microphones, a microphone array, etc. ; referred to herein as “the microphones 370”) and/or one or more audio transducers 344 (referred to hereinafter as “the transducers 344” or “the audio transducers 344”).

The input/output (I/O) 306 can include an analog I/O 322 (e.g., one or more wires, cables, and/or other suitable communication links configured to carry analog signals) and/or a digital I/O 324 (e.g., one or more wires, cables, or other suitable communication links configured to carry digital signals). In some examples, the analog I/O 322 is an audio line-in input connection comprising, for example, an auto-detecting 3.5 millimeter (mm) audio line-in connection. In some examples, the digital I/O 324 comprises a Sony/Philips Digital Interface Format (S/PDIF) communication interface and/or cable (or cable connection), and/or a Toshiba Link (TOSLINK) cable (or cable connection). In some examples, the digital I/O 324 comprises a High-Definition Multimedia Interface (HDMI) interface and/or cable. In some examples, the digital I/O 324 includes one or more wireless communication links comprising, for example, a radio frequency (RF), infrared, WI-FI, BLUETOOTH, or another suitable communication link. The analog I/O 322 and the digital I/O 324 may comprise interfaces (e.g., ports, plugs, jacks, etc.) configured to receive connectors of cables transmitting analog and digital signals, respectively, without necessarily including cables.

In some examples, the playback device 112 receives media content (e.g., audio content comprising music, speech, and/or other sounds) from a local audio source 320 via the input/output 306 (e.g., a cable, a wire, a PAN, a BLUETOOTH connection, an ad hoc wired or wireless communication network, and/or another suitable communication link). The local audio source 320 can comprise, for example, a mobile device (e.g., a smartphone, a tablet, a laptop computer, etc.) or another suitable audio component (e.g., a television, a desktop computer, an amplifier, a phonograph (such as an LP turntable), a Blu-ray player, a memory storing digital media files, etc.). In some aspects, the local audio source 320 includes local music libraries on a smartphone, a computer, a networked-attached storage (NAS), and/or another suitable device (e.g., the storage device 208) configured to store media files. In certain examples, one or more of the playback devices 112 and/or the at least one control device 114 comprise the local audio source 320. In other examples, however, the media playback system 110 omits the local audio source 320 altogether. In some examples, the playback device 112a does not include the input/output 320 and receives all audio content via the network 118. In other examples, the playback device 112 receives operating power via the input/output 306 and receives all audio content via the network 118.

According to certain examples, the electronics 330, are configured to receive audio from an audio source (e.g., the local audio source 320) via the input/output 306 or from one or more of the computing device(s) 206 via the network 118, amplify the received audio, and output the amplified audio for playback via one or more of the transducers 344. In the illustrated example of FIG. 3B, the electronics 330 comprise one or more processors 332 (referred to hereinafter as “the processors 332”), memory 334, software code 336, a network interface 340, audio processing circuitry 346, one or more audio amplifiers 348 (referred to hereinafter as “the amplifiers 348”), and power 350 (e.g., one or more power supplies, batteries, power cables, power receptacles, batteries, induction coils, Power-over Ethernet (POE) interfaces, and/or other suitable sources of electric power). The power 350 may be coupled to the power button 308. In some examples, the electronics 330 optionally include other circuitry 338 (e.g., one or more sensors, video displays, touchscreens, battery charging bases, cameras, thermometers, barometers, hygrometers, etc.). In some examples, the electronics 330 optionally include voice processing circuitry 342, as described further below.

The processors 332 can comprise clock-driven computing devices configured to process data, and the memory 334 can comprise a computer-readable medium (e.g., a tangible, non-transitory computer-readable medium loaded with at least some of the software code 336) configured to store instructions for performing various operations and/or functions. The processors 332 are configured to execute the instructions stored on the memory 334 to perform one or more of the operations. The operations can include, for example, causing the playback device 112 to retrieve audio data from an audio source (e.g., one or more of the computing devices 206 or the local audio source 320), and/or from another playback device 112. In some examples, the operations further include causing the playback device 112 to send audio data to another playback device 112. Certain examples include operations causing the playback device 112 to pair with another playback device 112 to enable a multi-channel audio environment (e.g., bonded group, such as a stereo pair, etc.), as described further below.

The processors 332 can be further configured to perform operations causing the playback device 112 to synchronize playback of audio content with another one or more playback devices 112. During synchronous playback of audio content on a plurality of playback devices, a listener will preferably be unable to perceive time-delay differences between playback of the audio content on the various playback devices 112.

In some examples, the memory 334 is further configured to store data associated with the playback device 112, such as one or more groups of which the playback device 112 is a member, audio sources accessible to the playback device 112, and/or a playback queue that the playback device 112 (and/or another one or more playback devices) can be associated with. The stored data can comprise one or more state variables that are periodically updated and used to describe a state of the playback device 112. The memory 334 can also include data associated with a state of one or more of the other devices (e.g., the playback devices 112 and/or control device 114) of the media playback system 110. In some examples, the state data is shared during predetermined intervals of time (e.g., every 5 seconds, every 10 seconds, every 60 seconds, etc.) among at least some of the devices of the media playback system 110, so that one or more of the devices have the most recent data associated with the media playback system 110.

Continuing with the example of FIG. 3B, the network interface 340 is configured to facilitate transmission of data between the playback device 112 and one or more other devices on a data network such as, for example, the communication links 204, the cloud network 202, and/or the network 118. The network interface 340 is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 340 can parse the digital packet data such that the electronics 330 properly receive and process the data destined for the playback device 112.

In some examples, the network interface 340 includes a wireless interface 328. The wireless interface 328 (e.g., a suitable interface comprising one or more antennae) can be configured to wirelessly communicate with one or more other devices (e.g., one or more other playback devices 112 and/or the control device 114) that are communicatively coupled to the network 118 in accordance with a suitable wireless communication protocol (e.g., WI-FI, BLUETOOTH, LTE, etc.). In some examples, the network interface 340 optionally includes a wired interface 326 (e.g., one or more interfaces, ports, or receptacles configured to receive a network cable such as an Ethernet, USB-A, USB-C, and/or Thunderbolt cable) configured to communicate over a wired connection with other devices in accordance with a suitable wired communication protocol. In certain examples, the network interface 340 includes the wired interface 326 and omits the wireless interface 328. In some examples, some or all of the components of the input/output 306 form part of the network interface 340, or vice versa. In other examples, the electronics 330 may omit the network interface 340 and transmit and receive media content and/or other data via another communication path (e.g., the input/output 306).

Still referring to FIG. 3B, the audio processing circuitry 346 is configured to process and/or filter data comprising media content received by the electronics 330 (e.g., via the input/output 306 and/or the network interface 340) to produce output audio signals. In some examples, the audio processing circuitry 346 comprises one or more digital-to-analog converters (DACs), audio enhancement circuitry, digital signal processors (DSPs), filters, and/or other suitable audio processing circuitry. In certain examples, the audio processing circuitry 346 can comprise one or more subcomponents of the processors 332. In some examples, the electronics 330 omit the audio processing circuitry 346. For example, the processors 332 may execute instructions stored on the memory 334 to perform audio processing operations to produce the output audio signals.

The amplifiers 348 are configured to receive and amplify the audio output signals produced by the audio processing circuitry 346 and/or the processors 332. The amplifiers 348 can comprise electronic devices and/or circuitry configured to amplify audio signals to levels sufficient for driving one or more of the transducers 344. For example, the amplifiers 348 may include one or more switching or class-D power amplifiers. In other examples, however, the amplifiers 348 include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain examples, the amplifiers 348 comprise a suitable combination of two or more of the foregoing types of power amplifiers. Moreover, in some examples, individual ones of the amplifiers 348 correspond to individual ones of the transducers 344. In other examples, however, the electronics 330 include a single one of the amplifiers 348 configured to output amplified audio signals to a plurality of the transducers 344. In some other examples, the electronics 330 omit the amplifiers 348.

The transducers 344 (e.g., one or more speakers and/or speaker drivers) are configured to receive electrical signals from the electronics 330 and to convert the received electrical signals into audible sound during playback. For example, the transducers 344 may be configured to receive the amplified audio signals from the amplifiers 348 and render or output the amplified audio signals as sound (e.g., audible sound waves having a frequency between about 20 Hertz (Hz) and 20 kilohertz (kHz)). In some examples, the transducers 344 can comprise a single transducer. In other examples, however, the transducers 344 comprise a plurality of audio transducers. In some examples, the transducers 344 comprise more than one type of transducer. For example, the transducers 344 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain examples, however, one or more of the transducers 344 comprise transducers that do not adhere to the foregoing frequency ranges. For example, one of the transducers 344 may comprise a mid-woofer transducer configured to output sound at frequencies between about 200 Hz and about 5 kHz. In some examples in which the transducers 344 include multiple transducers, all or some of the transducers can be configured to operate as a phased array to desirably adjust (e.g., narrow or widen) a radiation pattern of the transducers 344, thereby altering a user's perception of the sound emitted from the playback device 112. Furthermore, in some examples, the transducers 344 include one or more transducers configured to emit signals in a frequency range that is not audible to typical human listeners (e.g., ultrasonic signals). In other examples, the playback device 112 may omit the transducers 344.

The user interface 310 may include a plurality of control surfaces (e.g., buttons, dials, touch-sensitive surfaces (such as capacitive surfaces, for example), knobs, etc.) that allow a user to control various aspects of the playback device 112. Referring to FIG. 3C, in some examples, the user interface 310 includes one or more first control surfaces 312 that allow a user to control playback operations of the playback device 112 (e.g., “pause,” “play,” “skip,” “next,” “previous” or “repeat,” etc.) and one or more second control surfaces 314 for volume control. The user interface 310 may include one or more indicators 316 (e.g., one or more light emitting diodes (LEDs) or another suitable illuminator) that can be configured to indicate various statuses and/or operations of the playback device 112. For example, the one or more indicators 316 may illuminate, change color, flash, etc., in response to certain conditions, such as to indicate a power state, wireless connectivity (e.g., BLUETOOTH connection and/or pairing), or other conditions. In some examples, the one or more indicators 316 can be combined with one or more control surfaces. For example, the power button 308 may include an indicator that indicates (e.g., through illumination or color of illumination) a power state of the playback device 112. In examples in which the playback device 112 includes the microphones 370, the user interface 310 may include one or more microphone control surfaces and/or indicators 318. For example, the microphone control surfaces and/or indicators 318 may allow a user to activate or deactivate the microphones 370. In some examples, the microphone control surfaces and/or indicators 318 may illuminate only when the one or more microphones 370 are activated. In further examples, the microphone control surfaces and/or indicators 318 can include one or more indicators (e.g., one or more LEDs) that can be configured to remain solid during normal operation and to blink or otherwise change from solid to indicate a detection of voice activity.

It will be appreciated that the user interface 310 may include more or fewer control surfaces and/or illuminators than those illustrated in FIG. 3C. In addition, the user interface 310, or some components thereof, need not be positioned on the top surface 302a of the housing 302, but may be positioned elsewhere on/in the housing 302. Numerous variations are envisioned and intended to be part of this disclosure.

Referring again to FIG. 3B, as described above, in some examples, the playback device 112 includes the microphones 370 and can be configured to detect (and optionally respond to) sounds, such as voice input from the user 210. Accordingly, in such examples, the electronics 330 include voice processing circuitry 342. In some examples, the microphones 370 are configured to acquire, capture, and/or receive sound from an environment (e.g., the environment 100) and/or a room in which the playback device 112 is positioned. The received sound can include, for example, vocal utterances (e.g., by the user 210), audio played back by the playback device 112 and/or another playback device, background voices, ambient sounds, etc. Accordingly, in some examples, the housing 302 of the playback device 112 includes plurality of ports, holes or apertures 352, as shown in FIG. 3C, to allow sound to pass through to the microphones 370 contained within the housing 302. In some examples, the apertures 352 are positioned on/in the top surface 302a of the housing 302, as shown in FIG. 3C; however, in other examples, the apertures 352 may be positioned on/in other surfaces of the housing 302. The microphones 370 are configured to receive sound via the apertures 352 and to convert the received sound into electrical signals to produce microphone data.

The voice processing circuitry 342 receives and analyzes the microphone data to determine whether a voice input is present in the microphone data. The voice input can comprise, for example, an activation word followed by an utterance including a user request. An activation word is a word or other audio cue signifying a user voice input. An activation word can be used as a trigger to invoke a corresponding voice assistant service (VAS). For instance, in querying the AMAZON VAS, a user might speak the activation word “Alexa.” Other examples include “Ok, Google” for invoking the GOOGLE VAS and “Hey, Siri” for invoking the APPLE VAS. After detecting an activation word, for example, the voice processing circuitry 342 monitors the microphone data for an accompanying user request in the voice input. The user request may include, for example, a command to control certain operation of the playback device 112 and/or of another playback device (e.g., to start or stop playback of certain audio content or to alter the volume of playback), or to control (e.g., turn on or off or adjust) another device, such as a thermostat or an illumination device, for example. In some examples, after detection of one or more suitable voice commands, the playback device 112 is configured to transmit data associated with the received voice input to another device and/or a remote server (e.g., one or more of the computing devices 206) for further analysis. For example, the computing devices 206 may include a VAS server and/or otherwise operate a VAS configured to (i) process the received voice input data and (ii) facilitate one or more operations on behalf of the media playback system 110. Additional details regarding voice processing can be found, for example, in Lang '146 referenced above.

Referring to FIGS. 2A and 3B, in some examples, one or more of the computing devices 206, using the VAS, may analyze the data received from the playback device 112, determine an appropriate action based on the voice command, and transmit a message to the playback device 112 to perform the appropriate action. For instance, the user 210 may speak “[activation word], play [song title] or [artist].” The playback device 112 can, via the microphones 330 and the voice processing circuitry 342, record the user's voice utterance, determine the presence of a voice command, and transmit, via the communication links 204, the audio data having the voice command to the computing devices 206. The computing devices 206 may analyze the audio data and determine an action corresponding to the command. The computing devices 206 may then transmit a command to the playback device 112 to perform the determined action (e.g., play back audio content related to the specified song title or artist). The playback device 112 can receive the command and play back the audio content from a media content source and/or cause another playback device to play back the audio content from the media content source. As described above with respect to FIG. 2A, suitable content sources can include a device or storage (e.g., the storage device 208) communicatively coupled to the playback device 112 via the network 118, or the remote computing devices 206, for example. In other examples, the computing devices 206 may be configured to interface with media services on behalf of the media playback system 110. For example, after processing the voice input, instead of the computing devices 206 transmitting commands to the playback device 112 causing the media playback system 110 to retrieve the requested media from a suitable media service, the computing devices 206 may cause a suitable media service to provide the requested media to the media playback system 110 in accordance with the user's voice utterance. In other examples, the playback device 112 determines and/or performs one or more actions corresponding to the one or more voice commands without intervention or involvement of an external device, computer, or server (such as the computing devices 206).

Referring to FIG. 3D, in some examples, the voice processing circuitry 342 includes circuitry configured to facilitate voice command capture, including a voice activity detector 354, one or more beamformers 356 (referred to herein as “the beamformers”), acoustic echo cancellation (AEC) and/or self-sound suppression circuitry 358, an activation word detector 360, and voice/speech conversion circuitry 362 (e.g., voice-to-text and text-to-voice). In the example illustrated in FIG. 3D, the aforementioned parts of the voice processing circuitry 342 are shown as separate elements; however, as described above, some or all of the voice processing circuitry 342 can be implemented as subcomponents of the processors 332.

In some examples, the beamformers 356 and self-sound suppression circuitry 358 are configured to detect an audio signal and determine aspects of voice input represented in the detected audio signal, such as the direction, amplitude, frequency spectrum, etc. The voice activity detector 354 is operably coupled with the beamformers 356 and self-sound suppression circuitry 358 and configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise. The activation word detector 360 is configured to monitor and analyze received audio to determine if any activation words (e.g., wake words) are present in the received audio. The activation word detector 360 may analyze the received audio using an activation word detection process. If the activation word detector 360 detects an activation word, the playback device 112 may process voice input contained in the received audio. Example activation word detection processes accept audio as input and provide an indication of whether an activation word is present in the audio. Many activation word detection processes are known and commercially available. In some examples, the activation word detector 360 runs multiple activation word detection processes on the received audio simultaneously (or substantially simultaneously). As noted above, different voice services can use different activation words for invoking their respective voice service. To support multiple services, the activation word detector 360 may run the received audio through the activation word detection process for each supported voice service in parallel, for example.

The speech/text conversion circuitry 362 may facilitate processing by converting speech in the voice input to text. In some examples, the electronics 330 can include voice recognition software that is trained to a particular user or a particular set of users associated with a household. Such voice recognition software may implement voice-processing that is tuned to specific voice profile(s). Services tuned to specific voice profiles may be less computationally intense than traditional voice activity services, which typically sample from a broad base of users and diverse requests that are not targeted to media playback systems.

### c. Example Control Devices

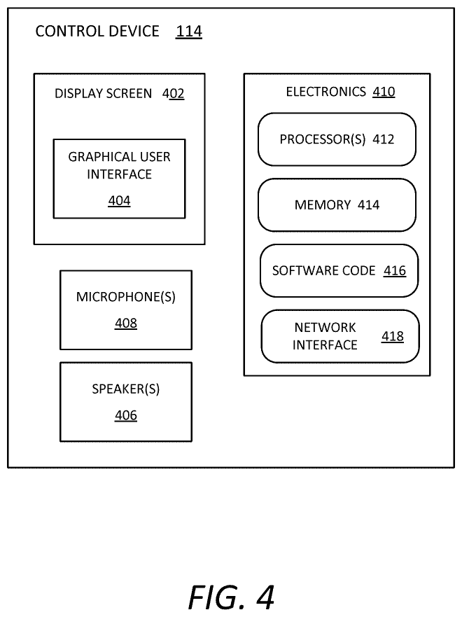

FIG. 4 is a partial schematic diagram of the control device 114, according to certain examples. As described above, the control device 114 may be a computing device, such as a mobile phone, for example, or may be a dedicated controller associated with the media playback system 110. In some examples, the control device 114 can be integrated with a playback device 112 or other electronic device.

In some examples, the control device 114 includes a display screen 402 that is configured to present a graphical user interface 404. The control device 114 may further include one or more speakers 406 configured to output sound to the user 210 of the control device, and one or more microphones 408 to capture voice input from the user 210. The control device further comprises electronics 410 for operation of the control device 114. In some examples, the electronics 410 comprise one or more processors 412 (referred to hereinafter as “the processors 412”), a memory 414, software code 416, and a network interface 418. The processors 412 can be configured to perform functions relevant to facilitating user access, control, and configuration of the media playback system 110. The memory 414 can comprise data storage that can be loaded with the software code 416 executable by the processors 412 to perform those functions. The software code 416 can comprise applications and/or other executable software configured to facilitate control of the media playback system 110. The memory 414 can be configured to store, for example, the software code 416, media playback system controller application software, and/or other data associated with the media playback system 110 and the user.

The network interface 418 is configured to facilitate network communications between the control device 114 and one or more other devices in the media playback system 110, and/or one or more remote devices (e.g., the computing devices 206). In some examples, the network interface 418 includes a wireless interface, such as the wireless interface 328 described above with reference to FIG. 3B, for example. The network interface 418 can be configured, for example, to transmit data to and/or receive data from the playback devices 112, the computing devices 206, and/or other devices. The transmitted and/or received data can include, for example, playback device control commands, state variables, playback space and/or playback group configurations. For instance, based on user input received via the graphical user interface 404, the network interface 418 can transmit a playback device control command (e.g., volume control, audio playback control, audio content selection, etc.) from the control device 114 to one or more of the playback devices 112. The network interface 418 can also transmit and/or receive configuration changes such as, for example, adding/removing one or more playback devices 112 to/from a group, adding/removing one or more groups of playback devices to/from a combination group or area, forming bonded or consolidated groups, and/or separating one or more playback devices 112 from a bonded group, among others.

The graphical user interface 404 is configured to receive user input and can facilitate control of the media playback system 110. The graphical user interface 404 may display information, such as media content art (e.g., album art, lyrics, videos, etc.), a playback status indicator (e.g., an elapsed and/or remaining time indicator), media content information (e.g., title, artist, album, genre, etc.), and/or other information. The graphical user interface 404 may present one or more control regions that can include selectable (e.g., via touch input and/or via a cursor or another suitable selector) icons or other control elements to allow the user 210 to control the media playback system 110. For example, the graphical user interface 404 may present control icons to cause one or more playback devices in a selected playback space or playback group to perform playback actions such as, for example, play or pause, fast forward, rewind, skip to next, skip to previous, enter/exit shuffle mode, enter/exit repeat mode, enter/exit cross fade mode, etc. A playback control region may also include selectable icons to modify equalization settings, playback volume, and/or other suitable playback actions. It will be appreciated, given the benefit of this disclosure, that user interfaces of varying formats, styles, and interactive sequences may be implemented on the control device 114 to provide control access to a media playback system. In some examples, the control device 114 may include other user interface components in addition to the graphical user interface 404. In other examples, the control device 114 may omit the graphical user interface 404.

It will further be appreciated that in some examples, the control device 114 may include additional circuitry not shown in FIG. 4, and/or may omit any of the circuitry shown in FIG. 4. For example, the control device 114 may omit the one or more speakers 406 and/or the one or more microphones 408. In some examples, the control device 114 may comprise a device (e.g., a thermostat, an IoT device, a network device, etc.) comprising a portion of the electronics 410 and the graphical user interface 404 (e.g., presented via the display screen 402 implemented as a touch screen) without any speakers or microphones. In examples in which the control device 114 comprises a device configured for functionality beyond control of the media playback system 110, the control device 114 may include various circuitry and electronic and/or other components associated with its other functionality.

### d. Suitable Playback Device Configurations

FIGS. 5A-D show example configurations of playback devices 112 groups. As described above, playback devices 112 may be assigned to various groups and/or playback spaces within the environment 100. For example, the playback devices 112a and 112b in Bedroom 1 may be assigned to one group (or playback space), and the playback device 112c in Bedroom 2 may be assigned to another group (or playback space). In some examples, the playback devices 112 within a group play audio content in synchrony. For example, two or more playback devices 112 in a group can play back the same audio content in synchrony with one another. In some examples, two or more playback devices 112 can be “bonded” to form a bonded group. Playback devices in a bonded group may have different playback responsibilities (e.g., channel responsibilities). For example, different playback devices in a bonded group can play back different channels of multi-channel audio content in synchrony with one another. Groups, including bonded groups, may be named based on rooms or other spaces within the environment 100 or may be given other identifying names by the user 210, for example.

In some implementations, multiple playback devices 112 may be bonded to form a bonded group, as described above. For example, referring to FIG. 5A, the playback device 112a can be bonded to the playback device 112b. As described above, bonded playback devices may have different playback responsibilities, such as responsibilities for certain audio channels. For example, the pair of playback devices 112a, 112b shown in FIG. 5A may be bonded so as to produce or enhance a stereo effect of audio content (e.g., to form a stereo pair). In this example, the playback device 112a may be configured to play a left channel audio component, while the playback device 112b may be configured to play a right channel audio component.

Additionally, bonded playback devices may have additional and/or different respective speaker drivers. For example, referring to FIG. 5B, the playback device 112e may be bonded with a playback device 112k and with the playback devices 112d and 112f to form a home theater group. In such examples, the different playback devices in the bonded group can have different audio channel responsibilities and/or different frequency responsibilities. For example, the playback device 112e can be configured to render a range of mid to high frequencies and the playback device 112k can be configured to render low frequencies. When unbonded, however, the playback device 112e may be configured to render a full range of frequencies. In some implementations, the playback devices 112d and 112f can be configured to form surround or “satellite” channels of the home theater system (e.g., left and right surround channels).

Playback devices 112 can be grouped and ungrouped in numerous ways. In addition, group assignments can change over time. Playback devices may be dynamically grouped and ungrouped to form new or different groups that synchronously play back audio content. For example, the user 210 can add and/or remove groups or playback spaces using the graphical user interface 404 of the control device 114. The user 210 may also add or remove playback devices 112 to/from groups using the graphical user interface 404 of the control device 114. In some examples, a group may be provided for control as a single user interface entity (e.g., “Bedroom 1”). Furthermore, in some examples, playback devices 112 may automatically join or leave groups based on detected movement or other conditions.

For example, referring to FIG. 5C, playback devices 112h and 112g may be bonded or otherwise grouped to form a group (e.g., “kitchen/dining area”). When the portable playback device 112j enters the kitchen 102e or dining area 102g, for example, the portable playback device 112j may be added to the group comprising the playback devices 112h and 112g. For example, the user may manually add the portable playback device 112j to the group, or the media playback system 110 may automatically add the portable playback device 112j to the group upon detecting that the portable playback device 112j is within a certain proximity to either or both of the playback devices 112h and/or 112g, for example. In some examples, proximity detection can be accomplished using radio our acoustic signaling. For example, playback devices can be configured to emit signals and to detect signals emitted from other playback devices. Based on signal strength (e.g., RSSI values) and/or other measures of the received signals at various playback devices (and/or at the control device 114), the media playback system 110 may determine an estimate of the proximity of one playback device to another, for example. Examples of techniques for localizing playback devices based on RSSI measurements are disclosed, for example, in Soto '9736 referenced above. Examples of playback devices equipped with ultrasonic presence detection are disclosed, for example, in Jones '6008 referenced above.

FIG. 5D illustrates another example in which the portable playback device 112i may automatically join a group based on being placed on the docking station 116. In the illustrated example, the docking station 116 is associated with a home theater bonded group comprising the playback devices 112d, 112e, and 112k, as described above. When the portable playback device 112i is placed on the docking station 116, the portable playback device 112i may become a satellite playback device in the home theater bonded group, for example.

Numerous other examples and configurations are possible, as will be appreciated, given the benefit of this disclosure, and are intended to be part of this disclosure. Additional details regarding grouping playback devices can be found, for example, in Kallai '080 referenced above.

As noted above, in some examples, groups of playback devices 112 can be combined (or grouped together) to form an “area.” An area may involve a cluster of two or more groups, for example, and can be used to distinguish a group of individual playback devices. For example, the user 210 may have a home theater bonded group comprising the playback devices 112e, 112d, 112f, and 112k along with a stereo bonded group comprising the playback devices 112h and 112g. The user 210 may form an area (e.g., “living space”) that comprises the two groups. This grouping of groups of playback devices to form areas may allow the user to form larger combinations of playback devices 112 more quickly than by forming a new group and adding numerous individual playback devices, for example. Areas can be named based on a combination of the names of individual playback spaces or groups within the area, or may be given unique names selected by the user 210. Further examples of techniques for implementing areas may be found, for example, in Wilberding '997 and Lambourne '853 referenced above.

Certain data may be stored in a memory of a playback device (e.g., the memory 334) as one or more state variables that are periodically updated and used to describe the state of a playback group, the playback device(s), and/or an area associated therewith. The memory may also include the data associated with the state of the other devices of the media playback system 110, and shared from time to time among the devices so that one or more of the devices have the most recent data associated with the system, as described above. In some examples, the memory may store instances of various variable types associated with the states. Variable instances may be stored with identifiers (e.g., tags) corresponding to type. For example, certain identifiers may be a first type to identify playback device(s) of a group, a second type to identify playback device(s) that may be bonded in the group, and a third type to identify an area (or combination group) to which the group may belong. For example, identifiers associated with the second bedroom 102c may indicate that the playback device 112c is the only playback device of a “Bedroom 2” group and not in an area. Identifiers associated with the dining area 102g may indicate that the dining area is part of a Dining+Kitchen area and that the playback devices 112h and 112g are grouped (e.g., as described above with reference to FIG. 5C). Identifiers associated with the kitchen 102e may indicate the same or similar information by virtue of the kitchen being part of the Dining+Kitchen area, for example. In other examples, the media playback system 110 may not implement areas.

### III. Examples of Compact Playback Devices

Portable playback devices offer convenience and utility in a wide variety of listening environments and circumstances. However, as described above, in some cases achieving a satisfactory balance between portability and output sound quality can be challenging. Examples described herein provide speaker assemblies having a compact, convenient form factor that are nonetheless capable of producing high-quality audio output. As described above, according to certain examples, this balance is achieved in part by leveraging a force-cancelling transducer configuration, examples of which are described further below. In addition, a housing for the playback device is configured to accommodate multi-directional acoustic energy flow produced by the force-cancelling transducer configuration, while allowing the playback device to be placed on, and be optionally attached to, a surface that may be substantially parallel to the face of one or more of the acoustic membranes/diaphragms of the force-cancelling transducer.

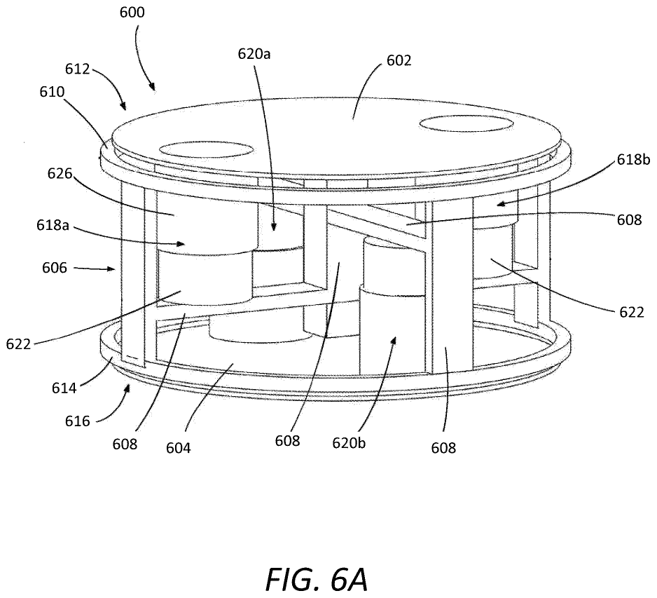

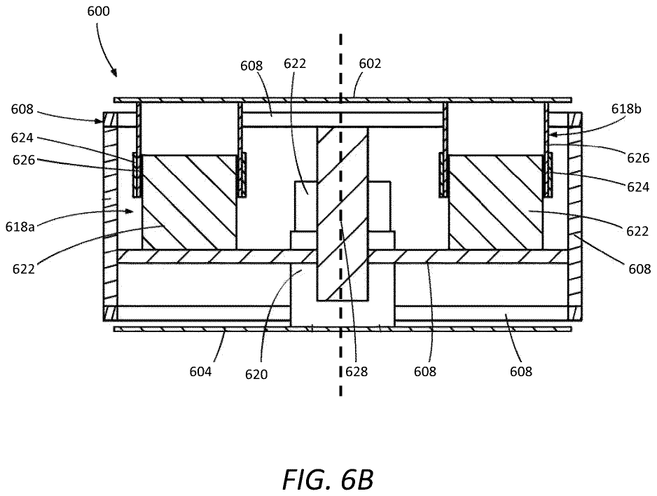

Referring to FIGS. 6A and 6B, there are illustrated schematic diagrams showing a perspective view (FIG. 6A) and a side view (FIG. 6B) of an example of a force-cancelling transducer according to certain aspects. The force-cancelling transducer 600 includes a first membrane 602 and a second membrane 604 arranged co-axially in an opposed relation to each other. In some examples, the membranes 602, 604 have a flat, circular configuration. A flat configuration may advantageously reduce the profile (e.g., height) of the speaker assembly; however, in other examples, the membranes 602, 604 can have other configurations. For example, the membranes 602, 604 may be rectangular rather than circular, and/or may have surfaces that are not flat. Scheek '0009 referenced above discloses various membrane shapes and configurations that may be used for the first and second membranes 602, 604 in certain examples. A rear volume 606 is defined between the first and second membranes 602, 604 and shared by the first and second membranes 602, 604. Mechanical vibrations from movement of the membranes 602, 604 in use are cancelled due to the opposed configuration of the membranes.

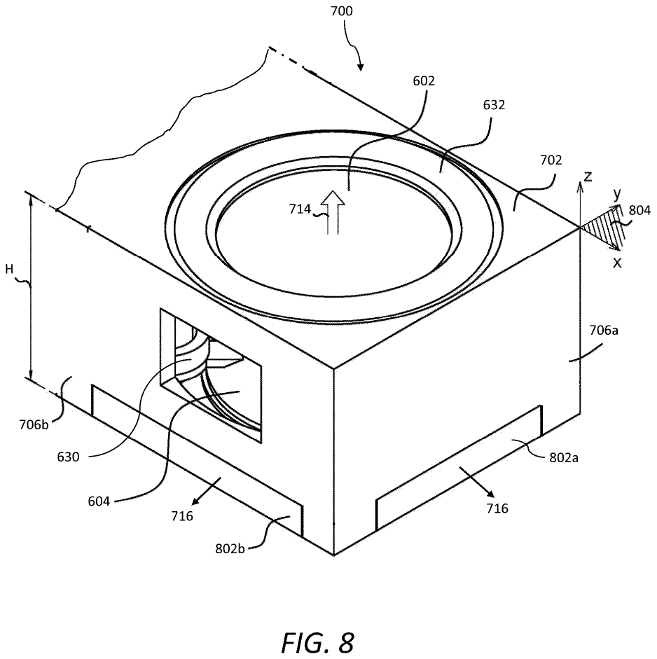

According to certain examples, the force-cancelling transducer 600 includes a frame 608 having a first rim 610 provided at a first end 612 and a second rim 614 provided at a second end 616 of the frame 16. In some examples, the first and second rims 610, 614 are circular to match the configuration of the first and second membranes 602, 604. The first membrane 602 is provided near the first end 612 of the frame 608 and the second membrane 604 is provided near the second end 616 of the frame 608. Although not shown in FIGS. 6A and 6B, the first membrane 602 may be mounted to the first rim 610 via a first surround (not shown) and the second membrane 604 may be mounted to the second rim 614 via a second surround (632; see FIG. 8).

According to certain examples, a driver assembly (630; see FIG. 8) is provided for each of the first and second membranes 602, 604. The driver assembly for the first membrane 602 includes a plurality of motors 618 (individually identified as motors 618a, 618b) operatively coupled to the first membrane 602. Similarly, the driver assembly for the second membrane 604 includes a plurality of motors 620 (individually identified in FIG. 6A as motors 620a, 620b) operatively coupled to the second membrane 604. The motors 618 and 620 are mounted on the frame 608. As shown in FIGS. 6A and 6B, in some examples, the frame 608 is constructed such that the motors 618 are vertically offset from the motors 620. In some examples, each motor 618, 620 comprises a magnet 622 that is attached to the frame 608, and a voice coil 624 provided on a former 626. The former 626 of each motor 618 is attached to the first membrane 602. Similarly, the former 626 of each motor 620 is attached to the second membrane 604. In other examples, the voice coils 624 can be formed without a former (known as formerless voice coils or air coils), in which case the voice coils 624 may be directly attached to the respective membranes 602, 604. The voice coils 624, either directly or via the formers 626, exert a drive pressure against the membranes 602, 604. In some examples, the magnets 622 are rare-earth magnets, such as neodymium magnets, which advantageously have a high magnetic flux density. However, in other examples, the magnets 622 may be of any suitable type.

In the example illustrated in FIGS. 6A and 6B, the force-cancelling transducer 600 includes four motors, two motors 618 attached to the first membrane 602 and two motors 620 attached to the second membrane 604. However, in other examples, the force-cancelling transducer 600 may include more than or fewer than two motors 618, 620 per membrane 602, 604, respectively. Using multiple separate motors 618, 620 for the membranes 602, 604 may increase the efficiency with which the membranes are moved, making it possible to reproduce lower frequencies in a small, mostly closed housing. Further, attaching multiple motors to each membrane may increase linearity and membrane rigidity, which are important for high excursion drivers typically used in low frequency reproduction speaker systems. In some examples, the motors 618, 620 are positioned around the periphery of the membranes 602, 604, as shown in FIGS. 6A and 6B, which may be an advantageous arrangement in terms of reducing the vertical profile (e.g., height) of the speaker assembly 600. However, in other examples, the motors 618, 620 may be positioned between the membranes 602, 604 or elsewhere.

In some examples, to drive the membranes 602, 604 to produce acoustic energy (and therefore sound), the voice coils 624 are configured to move relative to the magnets 622, which are fixedly attached to the frame 608. However, in other examples, the voice coils 624 (or formers 626) can be fixedly attached to the frame 608 and the magnets 622 can be attached to the membranes 602, 604 and configured to move (with the membranes 602, 604) relative to the voice coils 624. In either configuration, to produce acoustic energy, the membranes 602, 604 move towards and away from one another along a transducer axis 628, driven by the driver assemblies 630. As a result, the first and second membranes 602, 604 produce acoustic energy that may be directed primarily in directions parallel to (or along) the transducer axis 628.

Additional examples of force-cancelling transducer assemblies, and aspects thereof, are described in Scheek '107, Scheek '415, Scheek '0009, Scheek '6176, and Scheek '4554 referenced above. Any of these examples, or variations thereof, may be used alone or in combination to implement examples of the force-cancelling transducer 600.

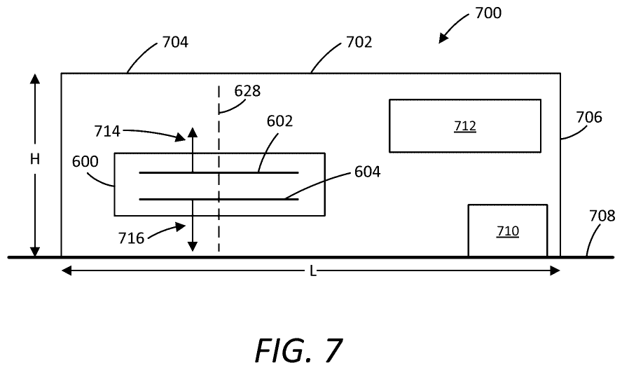

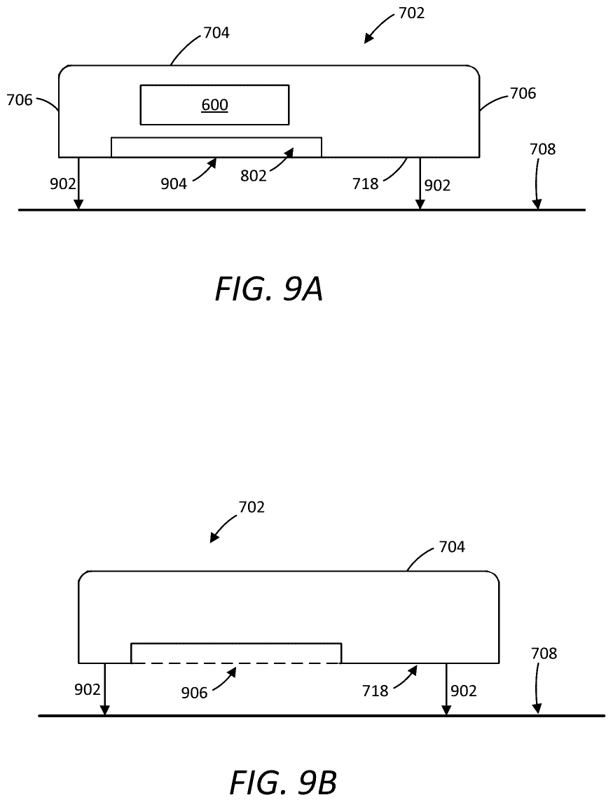

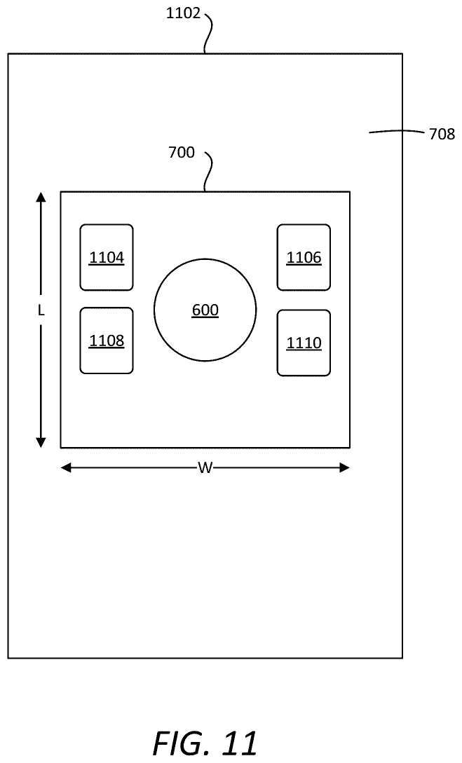

Referring now to FIG. 7, according to certain examples, a speaker assembly 700 comprises an example of the force-cancelling transducer 600 disposed within a housing 702. The housing 702 may be an example of the playback device housing 302 described above. As described above, in some examples, the housing 702 has a compact form factor. For example, the housing 702 may have a length, L, in a range of 2-4 inches, a width, W (see FIG. 11), in a range of 1-2.5 inches, and a height, H, in a range of 0.5-1 inch. The housing 702 may include a front face 704 and at least one side wall 706. In some examples, the side wall(s) 706 extend substantially perpendicular to the front face 704. The housing 702 may further include a rear face 718 (see FIG. 9A) that may be substantially parallel to the front face 704. As described further below, the speaker assembly 700 may be configured to be positioned against (e.g., with the rear face 718 in contact with), and optionally removably attached to, a surface 708. Accordingly, the speaker assembly 700 may include at least one attachment mechanism 710 (e.g. one or more magnets) for removably attaching the speaker assembly 700 to the surface 708. In some examples, the surface 708 is a substantially planar surface. In some such examples, when the speaker assembly 700 is positioned against the surface 708, the front face 704 and/or the rear face 718 of the housing 702 may be substantially parallel to the surface 708. In some examples, the front face 704 is rectangular, and the at least one side wall 706 includes four side walls. However, in other examples, the housing 702 may have other shapes.

The speaker assembly 700 may be or may be part of a playback device, such as any of the playback devices 112 described above. Accordingly, the speaker assembly 700 may include electronics 712, components and configurations of which may vary depending on the implementation of the speaker assembly 700. For example, the electronics 712 may include the audio processing circuitry 346 and optionally the network interface 340 described above. In examples in which the speaker assembly 700 is a playback device, the electronics 712 may include some or all of the electronics 330, the user interface 310, and/or other components/circuitry. In some examples, the electronics 712 includes one or more additional transducers, as described further below. In some examples in which the speaker assembly 700 is a playback device, components of the user interface 310 may be provided on the front face 704 and/or one or more of the side walls 706 of the housing 702 (e.g., as illustrated in FIGS. 3A and 3C).

As shown in FIG. 7, in some examples, the force-cancelling transducer 600 is positioned within the housing 702 such that the transducer axis 628 is substantially perpendicular to the front face 704 of the housing 702, and therefore, to the surface 708 when the speaker assembly 700 is placed against the surface 708. Accordingly, the major surfaces of the first and second membranes 602, 604 may be substantially parallel to (or aligned with) the front face 704 of the housing 702. As a result, first acoustic energy 714 and second acoustic energy 716 produced by the first and second membranes 602, 604, respectively, and directed along the transducer axis 628 as described above, may be directed towards and away from the front face 704 of the housing 702 and the rear face 718 of the housing 702 positioned against surface 708, respectively. Although not shown in FIG. 7, in some examples, the front face 704 of the housing 702 includes at least one speaker vent to allow the acoustic energy 712 to be directed through the front face 704. As described further below, the housing 702 may be configured with one or more acoustic ports that allow the speaker assembly 700 to redirect the acoustic energy 716 (that would otherwise be directed towards the rear face 718 and the surface 708) to an exterior of the housing 702 in one or more directions that may be away from and/or parallel to (but not directly into) the rear face 718 (and therefore the surface 708).

For example, referring to FIG. 8, there is illustrated a portion of an example of the speaker assembly 700. In this example, the housing 702 includes at least a first acoustic port 802a formed in a first side wall 706a of the housing 702, and a second acoustic port 802b formed in a second side wall 706b of the housing 702. In some examples, although not shown in FIG. 8, the housing 702 may further include a third acoustic port formed in a third side wall that is opposite the second side wall 706b. As described above, the force-cancelling transducer 600 can be positioned (as shown in FIG. 7) such that the first and second membranes 602, 604 are substantially parallel with a plane 804 of the front face 704 (and rear face 718) of the housing 702. In the example shown in FIG. 8, the second side wall 706b is shown with a partial cut-out to illustrate the second membrane 604 and one of the drive assemblies 630 disposed within the housing 702. As shown in FIG. 8, the acoustic energy 716 from the second membrane 604 is directed via the acoustic ports 802a, 802b to an exterior of the housing 702. In some examples, a height of the acoustic ports 802 (e.g., measured in the same dimension/direction as the height, H, of the housing 702, and thus extending perpendicularly along at the at least one side wall 706) is in a range of 0.5 millimeters (mm) to 2 mm, or in a range of 1 mm to 1.5 mm, for example. Although not shown in FIG. 8, in some examples, the housing 702 comprises a scrim cloth positioned over the one or more acoustic ports 802 to prevent dust or other small particles from entering the housing 702.

According to certain examples, the acoustic ports 802 are positioned proximate edges of the respective side walls 706, as shown in FIG. 8. Referring to FIGS. 9A and 9B, in some examples, the rear face 718 of the housing 702 forms a boundary of the acoustic ports 802, as shown in FIG. 9A. As described above, the speaker assembly 700 can be configured such that the rear face 718 rests against the surface 708 when the speaker assembly 700 is placed on the surface 708, as indicated by arrows 902 in FIGS. 9A and 9B. In some examples, the rear face 718 of the housing 702 includes a portion 904 that extends below the force-cancelling transducer 600 and forms one of the boundaries of one or more of the acoustic ports 802, as shown in FIG. 9A. However, in other examples, the rear face 718 may omit some or all of the portion 904. In such examples, a boundary 906 of the acoustic ports 802 may be formed by the surface 708 when the housing 702 is placed in contact with the surface 708, as indicated in FIG. 9B.

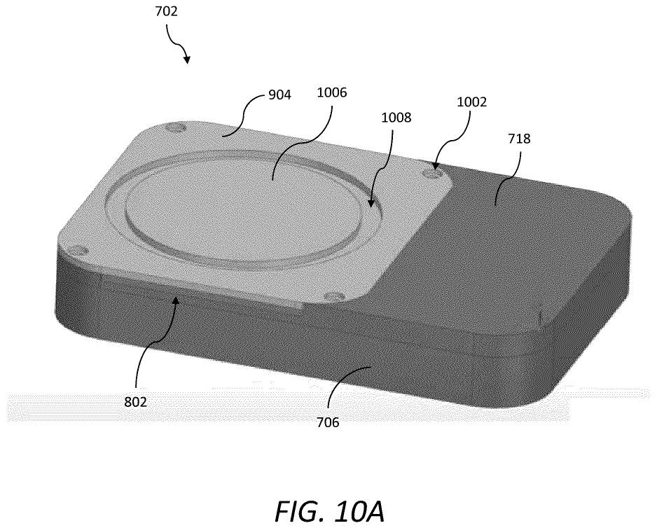

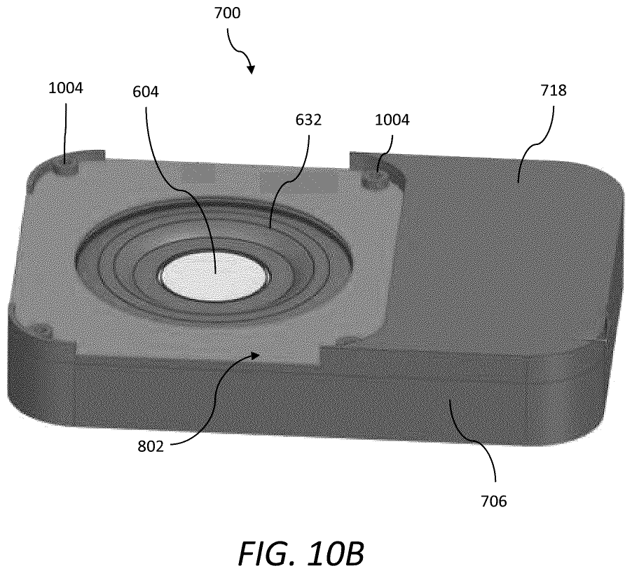

According to certain examples, the portion 904 of the rear face 718 of the housing 702 is removably attached to the housing 702. An example is illustrated in FIGS. 10A and 10B. FIG. 10A is a perspective view showing an example of the housing 702 with a removable portion 904 of the rear face 718. FIG. 10B is a perspective view showing an example of the speaker assembly 700 with the removable portion 904 of the rear face 718 of the housing 702 removed. Accordingly, in FIG. 10B, the second membrane 604 and the second surround 632 are visible. In the example illustrated in FIGS. 10A and 10B, the removable portion 904 is attachable to the housing 702 via four fasteners (e.g., screws) that extend through fastener receptables 1002 in the removable portion 904 into fastener receiving portions 1004 in the housing 702. Thus, using the fasteners, the removable portion 904 can be removably secured to the housing 702. In other examples, however, more or fewer than four fasteners can be used, or another fastening mechanism can be used (e.g., mating slides/rails, clips, magnets, etc.). In some examples, an interior surface of the removable portion 904 is substantially flat, at least in a region that extends over the second membrane 604.

As described above, the speaker assembly 700 can be configured to be removably attachable to the surface 708. In some examples, removable attachment of the speaker assembly 700 to the surface 708 can be achieved using one or more magnets. For example, referring to FIG. 10A, the rear face 718 of the housing 702 may include at least one magnet compartment 1006 in which one or more magnets can be disposed. In some examples, the one or more magnets are neodymium magnets. In the example illustrated in FIG. 10A, the at least one magnet compartment 1006 is formed within the removable portion 904 of the rear face 718; however, in other examples, the at least one magnet compartment 1006 can be formed in another region of the rear face 718. In the illustrated example, the at least one magnet compartment 1006 has a circular shape; however, in other examples, the at least one magnet compartment may have a different shape. The magnet(s) disposed within the at least one magnet compartment 1006 can be used to magnetically attach the rear face 718 of the housing 702 to a magnetic region of the surface 708 (e.g., if at least a portion of the surface 708 is formed of a magnetizable metal or other magnetic material). In other examples, a device (e.g., a mobile phone) of which the surface 708 is a part may include one or more magnets disposed proximate the surface 708 to allow the speaker assembly 700 to be magnetically attached to the surface 708 of the device.

In some examples, as illustrated in FIG. 10A, the at least one magnet compartment 1006 may be surrounded, or at least partially surrounded, by an indentation 1008 in the rear face 718. The indentation 1008 may assist a user in positioning the speaker assembly 700 with respect to the device comprising the surface 708 such that a strong magnetic attachment between the speaker assembly 700 and the device can be achieved to securely fasten the speaker assembly 700 to the device. In the example illustrated in FIG. 10A, the indentation 1008 is circular; however, in other examples, the indentation 1008 may have a different shape.

In some examples, the removable portion 904 may be a metal plate, such that the removable portion can at least partially shield the underlying force-cancelling transducer 600 from the magnets in the at least one magnet compartment 1006 and/or the device to which the speaker assembly 700 is attached. However, in other examples, the removable portion 904 may be made of a plastic or other non-metal material.

Referring to FIG. 11, there is illustrated an example of the speaker assembly 700 attached to a device 1102. As described above, the device 1102 may be a mobile phone or other electronic device, such as a tablet, computer, television, or docking station, for example. In some examples, when attached to the device 1102, the speaker assembly 700 can be used to provide, or supplement, audio output for the device 1102. For example, the device 1102 can be configured to act as a control device 114 for audio playback using the speaker assembly 700. In some such examples, the device 1102 includes a user interface (e.g., the graphical user interface 404) to allow a user to initiate and/or control audio playback using the speaker assembly 700. The device 1102 may further include media storage and/or a communication interface to allow the user to access audio content to be played back using the speaker assembly 700. In some examples, playback parameters, such as volume, content selection, start, stop, pause, etc., may be controlled via the device 1102 and/or via a user interface (e.g., the user interface 310) of the speaker assembly 700. In some examples, the speaker assembly 700 includes a sensor (e.g., as part of the electronics 712) to detect when the speaker assembly 700 is attached to the device 1102. In some examples, the speaker assembly and/or the device 1102 can be configured to alter playback of audio content based on detecting (e.g., via the sensor) that the speaker assembly 700 is attached to the device 1102. For example, upon attaching the speaker assembly 700 to the device 1102, the speaker assembly 700 may automatically assume responsible for audio output of audio content from the device 1102. Accordingly, the electronics 712 may further include various circuitry configured to interoperate with the device 1102 and/or other external devices to allow the speaker assembly 700 to play back audio content received from the device 1102. For example, as described above, the electronics 712 may include a communication interface to allow the speaker assembly to receive audio data from the device 1102. Using the speaker assembly 700 to replace, or supplement, audio output from the device 1102 may allow a user to have an improved sound experience relative to listening to the audio content played back via internal transducers of the device 1102. For example, as described above, the speaker assembly 700, by leveraging the use of the force-cancelling transducer 600, may be able to produce louder and/or more acoustically “full” (e.g., having more bass) sound than may be produced using the internal transducers of a mobile phone or other small computing device. Accordingly, an improved listening experience, particularly for music and/or audio associated with video content (e.g., a movie, or television soundtrack), may be achieved using the speaker assembly 700.

As described above, in some examples, the speaker assembly 700 includes a plurality of additional transducers as well as the force-cancelling transducer 600. In the example illustrated in FIG. 11, the speaker assembly 700 includes four additional transducers 1104, 1106, 1108, and 1110. However, in other examples, the speaker assembly 700 may include more than or fewer than four additional transducers. In some examples, the force-cancelling transducer 600 is configured to produce the acoustic energy 714, 716 in a first frequency range, and the additional transducers 1104-1110 are configured to output acoustic energy in a second frequency range, the first frequency range being lower in frequency than the second frequency range. For example, the force-cancelling transducer 600 can be configured to operate primarily as a sub-woofer, whereas the additional transducers 1104-1110 may be tweeters.

In some examples, as illustrated in FIG. 11, the additional transducers 1104-1110 are positioned laterally on either side of the force-cancelling transducer 600. In the example shown, with the device 1102 in a “portrait” configuration as illustrated, the additional transducers 1104 and 1108 are positioned laterally to the left of the force-cancelling transducer 600 and the additional transducers 1108 and 1110 are positioned laterally to the right of the force-cancelling transducer 600. In some examples, the speaker assembly 700 may omit the additional transducers 1108 and 1110, such that the speaker assembly includes only one additional transducer (e.g., 1104 and 1106) positioned on either side of the force-cancelling transducer 600.

In some examples, the additional transducers 1104-1110 can be configured to produce spatial acoustic effects depending on an orientation of the device 1102. For example, in the configuration shown in FIG. 11, the additional transducers 1104 and 1108 can be assigned playback responsibility for the left audio channel(s), while the additional transducers 1106 and 1110 can be assigned playback responsibility for the right audio channel(s). In this manner, the speaker assembly 700 can be configured to produce a stereo sound effect, with the additional transducers 1104, 1108 and 1106, 1110 configured as a stereo pair, as described above with reference to FIG. 5A, for example. In some examples, the speaker assembly 700 can include (e.g., as part of the electronics 712) a sensor (e.g., a gyroscope or accelerometer) that is configured to detect an orientation of the speaker assembly. The speaker assembly 700 may then alter playback of audio content depending on the detected orientation. For example, if the speaker assembly 700 and device 1102 are in the portrait orientation as shown in FIG. 11A, the additional transducers 1104-1110 can be configured for stereo playback as described above. If the device 1102 and/or speaker assembly are rotated 90 degrees to the left, for example (into “landscape” orientation), such that the additional transducers 1104 and 1108 are positioned below the force-cancelling transducer 600 and the additional transducers 1106 and 1110 are positioned above the force-cancelling transducer 600, channel assignments for the additional transducers 1104-1110 can be altered. For example, if the arrangement of the additional transducers 1104-1110 is such that in the landscape orientation there is not a significant lateral spacing between pairs of the additional transducers, the additional transducers 1104-1110 can be configured to render the audio content in “mono” (e.g., all the additional transducers play back the same audio channels) rather than stereo. Alternatively, if the additional transducers are arranged such that, in the landscape orientation, the additional transducers 1104 and 1106 are sufficiently laterally spaced apart from the additional transducers 1108 and 1110 such that stereo effects can be perceived, then a new stereo grouping can be implemented based on detecting (e.g., via the sensor) that the speaker assembly is in the landscape orientation. For example, the additional transducers 1104 and 1106 can be assigned playback responsibility for the left audio channel(s), while the additional transducers 1108 and 1110 can be assigned playback responsibility for the right audio channel(s), or vice versa. Variations will be apparent given the benefit of this disclosure and are intended to be part of this disclosure.

### IV. Conclusion

The above discussions relating to playback devices, control devices, playback zone configurations, and media content sources provide only some examples of operating environments within which functions and methods described herein may be implemented. Other operating environments and configurations of media playback systems, playback devices, and network devices not explicitly articulated as part of this disclosure may also be applicable and suitable for implementation of the functions and methods described herein.

The description above discloses, among other things, various example systems, methods, apparatus, and articles of manufacture including, among others, firmware and/or software code executed on hardware. It is understood that such examples are merely illustrative and should not be considered as limiting. For example, it is contemplated that any or all of the firmware, hardware, and/or software aspects can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “example” mean that a particular element, structure, or characteristic described in connection with the example can be included in at least one example of the technology described herein. The appearances of these terms in various places in the specification are not necessarily all referring to the same example, nor are separate or alternative examples mutually exclusive of other examples. As such, the examples described herein, explicitly and implicitly understood by one skilled in the art, can be combined with other examples.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples of the present disclosure can be practiced without certain, specific details. In other instances, well known methods, procedures, components, and circuitry have not been described in detail to avoid unnecessarily obscuring aspects of the examples. Accordingly, the scope of the present disclosure is defined by the appended claims rather than the foregoing description of examples.

No appended claim is to be read to cover a purely software and/or firmware implementation. Each claim reciting code is hereby expressly defined to include a tangible, non-transitory medium such as a memory, DVD, CD, Blu-ray, and so on, storing the code.

### V. Additional Examples

The following examples pertain to further arrangements and/or implementations, from which numerous permutations and configurations will be apparent.
Example 1 is a speaker assembly comprising: a housing having a front face, a rear face, and at least one side wall having a first edge coupled to the front face along a perimeter of the front face, the at least one side wall extending perpendicularly to the front face, the housing including one or more acoustic ports formed in the at least one side wall, the one or more acoustic ports being positioned at a second edge of the side wall opposite to the first edge; and a transducer at least partially disposed within the housing. The transducer comprises a first membrane and a second membrane arranged coaxially about a transducer axis in an opposed relation to each other and configured to move towards and away from the front face along the transducer axis, wherein the transducer axis is parallel to the at least one side wall, and a driver assembly configured to drive the first and second membranes to produce acoustic energy. The speaker assembly is configured to direct first acoustic energy from the first membrane to an exterior of the housing via the front face, and to direct second acoustic energy from the second membrane to the exterior of the housing via the one or more acoustic ports.
Example 2 includes the speaker assembly of Example 1, wherein the rear face does not extend over the second membrane.
Example 2 includes the speaker assembly of Example 1, wherein the rear face includes a first portion and a second portion, the second portion covering the second membrane, wherein the at least one side wall extends between the front face and the rear face such that the housing forms an enclosure at least partially surrounding the transducer.
Example 4 includes the speaker assembly of Example 3, wherein the second portion is detachable and secured to the speaker assembly with one or more fasteners.
Example 5 includes the speaker assembly of one of Examples 3 or 4, wherein the second portion comprises a metal plate.
Example 6 includes the speaker assembly of any one of Examples 3-5, wherein the second portion forms a boundary of the one or more acoustic ports.
Example 7 includes the speaker assembly of Example 6, wherein a height of the one or more acoustic ports is in a range of 0.5 millimeters (mm) to 2 mm, the height extending perpendicularly along the at least one side wall from the boundary at the second portion.
Example 8 includes the speaker assembly of Example 7, wherein the height is in a range of 1 mm to 1.5 mm.
Example 9 includes the speaker assembly of any one of Examples 3-8, wherein an interior surface of the second portion is flat.
Example 10 includes the speaker assembly of any one of Examples 3-9, wherein the second portion includes at least one magnet compartment formed therein.
Example 11 includes the speaker assembly of Example 10, further comprising one or more magnets disposed within the at least one magnet compartment.
Example 12 includes the speaker assembly of Example 11, wherein the one or more magnets are neodymium magnets.
Example 13 includes the speaker assembly of one of Examples 10 or 11, further comprising: a communication interface coupled to the driver assembly; at least one processor coupled to the communication interface; and a tangible computer-readable storage medium coupled to the at least one processor and storing program instructions that when executed by the at least one processor cause the speaker assembly to: receive, via the communication interface, audio data from an external device magnetically coupled to the speaker assembly via the one or more magnets, and operate the transducer to produce the acoustic energy based on the audio data.
Example 14 includes the speaker assembly of any one of Examples 10-13, wherein an exterior surface of the rear face includes an indentation surrounding the at least one magnet compartment.
Example 15 includes the speaker assembly of Example 14, wherein the indentation is circular.
Example 16 includes the speaker assembly of any one of Examples 1-15, further comprising one or more additional transducers disposed within the housing.
Example 17 includes the speaker assembly of Example 16, wherein the transducer is configured to produce the acoustic energy in a first frequency range, wherein the one or more additional transducers are configured to output acoustic energy in a second frequency range, and wherein the first frequency range is lower in frequency than the second frequency range.
Example 18 includes the speaker assembly of any one of Examples 1-17, wherein the front face is rectangular, and wherein the at least one side wall includes four side walls.
Example 19 includes the speaker assembly of Example 18, wherein the one or more acoustic ports includes three acoustic ports respectively formed in three of the four side walls.
Example 20 includes the speaker assembly of any one of Examples 1-19, wherein the transducer comprises a frame having first and second ends, the frame including first and second rims provided at the first and second ends, respectively, wherein the first membrane is mounted to the first rim via a first membrane surround, and wherein the second membrane is mounted to the second rim via a second membrane surround.
Example 21 includes the speaker assembly of Example 20, wherein the driver assembly comprises a first plurality of motors operatively coupled to the first membrane, and a second plurality of motors operatively coupled to the second membrane, the first and second pluralities of motors being provided on the frame.
Example 22 includes the speaker assembly of Example 21, wherein the motors are provided on the frame around a periphery of the first and second membranes.
Example 23 includes the speaker assembly of one of Examples 21 or 22, wherein each motor comprises a magnet and a voice coil.
Example 24 includes the speaker assembly of any one of Examples 1-23, wherein the housing comprises a scrim cloth positioned over the one or more acoustic ports.
Example 25 is a playback device comprising: a housing defining an interior volume, the housing comprising a front face, a rear face, and a side wall extending between the front face and the rear face; a transducer disposed in the interior volume of the housing, the transducer comprising a first membrane and a second membrane in an opposed relation to each other and configured to move towards and away from each other, and a driver assembly configured to drive the first and second membranes to produce acoustic energy; at least one additional transducer disposed in the interior volume of the housing; a speaker vent in the front face configured to direct first acoustic energy from the first membrane to an exterior of the housing; and a plurality of acoustic ports in the side wall configured to direct second acoustic energy from the second membrane to the exterior of the housing.
Example 26 includes the playback device of Example 25, wherein the housing is rectangular.
Example 27 includes the playback device of Example 26, wherein the side wall comprises opposing first and second regions and a third region extending from an edge of the first region to an edge of the second region; and wherein the plurality of acoustic ports includes a first acoustic port formed in the first region, a second acoustic port formed in the second region, and a third acoustic port formed in the third region.
Example 28 includes the playback device of Example 26, wherein the at least one side wall includes four side walls, and wherein the plurality of acoustic ports includes three acoustic ports respectively formed in three of the four side walls.
Example 29 includes the playback device of any one of Examples 25-28, further comprising: a communication interface disposed in the interior volume of the housing; at least one processor disposed in the interior volume of the housing; and a non-transitory computer-readable storage medium disposed in the interior volume of the housing, coupled to the at least one processor, and storing program instructions executable by the at least the processor to configure the playback device to receive, via the communication interface, audio content from an external device, and play back the audio content via the transducer and the at least one additional transducer.
Example 30 includes the playback device of Example 29, further comprising at least one magnet disposed within the rear face.
Example 31 includes the playback device of Example 30, wherein the rear face comprises a magnet compartment that houses the at least one magnet, and wherein an exterior surface of the rear face includes an indentation surrounding the magnet compartment.
Example 32 includes the playback device of Example 31, wherein the indentation is circular.
Example 33 includes the playback device of any one of Examples 30-32, further comprising at least one sensor configured to detect attachment of the playback device to the external device and/or an orientation of the playback device.
Example 34 includes the playback device of Example 33, wherein the at least one additional transducer comprises: a first additional transducer positioned laterally to one side of the transducer; and a second additional transducer positioned laterally on an opposite side of the transducer such that the transducer is laterally positioned between the first and second additional transducers.
Example 35 includes the playback device of Example 34, wherein the program instructions include program instructions executable by the at least one processor to configure the playback device to alter playback of the audio content based on detection of attachment to the external device and/or the orientation of the playback device.
Example 36 includes the playback device of any one of Examples 25-35, wherein the transducer is configured to produce the acoustic energy in a first frequency range, wherein the at least one additional transducer is configured to output acoustic energy in a second frequency range, and wherein the first frequency range is lower in frequency than the second frequency range.
Example 37 includes the playback device of any one of Examples 25-36, wherein the rear face includes a first portion and a second portion, the second portion covering the second membrane, and wherein an internal surface of the second portion is flat.
Example 38 includes the playback device of Example 37, wherein the second portion is detachable and secured to the housing with one or more fasteners.
Example 39 includes the playback device of one of Examples 37 or 38 wherein the second portion comprises a metal plate.
Example 40 includes the playback device of any one of Examples 25-39, wherein the transducer comprises a frame having first and second ends, the frame including first and second rims provided at the first and second ends, respectively, wherein the first membrane is mounted to the first rim via a first membrane surround, and wherein the second membrane is mounted to the second rim via a second membrane surround.
Example 41 includes the playback device of Example 40, wherein the driver assembly comprises a first plurality of motors operatively coupled to the first membrane, and a second plurality of motors operatively coupled to the second membrane, the first and second pluralities of motors being provided on the frame.
Example 42 includes the playback device of Example 41, wherein the motors are provided on the frame around a periphery of the first and second membranes.
Example 43 includes the playback device of one of Examples 41 or 42, wherein each motor comprises a magnet and a voice coil.
Example 44 includes the playback device of any one of Examples 25-43, wherein the housing comprises a scrim cloth positioned over the plurality of acoustic ports.
Example 45 includes the playback device of any one of Examples 25-44, further comprising a user interface accessible via the housing and configured to control one or more operating characteristics of the playback device.
Example 46 includes the playback device of Example 45, wherein the one or more operating characteristics comprise one or more of a power status of the playback device, a volume of audio output from the playback device, or a playback status of the playback device.
Example 47 is a media playback system comprising: an external device; and a speaker assembly configured to magnetically couple to the external device, the speaker assembly comprising a housing having a front face, a rear face, and a side wall extending between the front face and the rear face, the housing including at least one magnet disposed within a first portion of the rear face to magnetically couple the rear face of the housing to the external device, the housing further including a first speaker vent in the front face and one or more acoustic ports in the side wall, and a transducer disposed within the housing, the transducer comprising a first membrane and a second membrane in an opposed relation to each other and configured to move towards and away from the front face, and a driver assembly configured to drive the first and second membranes to produce acoustic energy, a communication interface disposed within the housing, at least one processor disposed within the housing, and a non-transitory computer-readable medium disposed within the housing and storing program instructions executable by the at least one processor to cause the speaker assembly to obtain, via the communication interface, audio content from the external device, and play back, via the transducer, the audio content received from the external device.
Example 48 is a speaker assembly or playback device comprising a housing having a housing surface, a force-cancelling transducer disposed within the housing, and one or more magnets for magnetically attaching the housing surface of the speaker assembly or playback device to an external device, wherein the housing comprises one or more acoustic ports configured to direct acoustic energy from the force-cancelling transducer that would otherwise be directed towards the housing surface to an exterior of the housing in one or more directions away from and/or substantially parallel to the housing surface.

1. A speaker assembly comprising:
a housing having a front face, a rear face, and at least one side wall having a first edge coupled to the front face along a perimeter of the front face, the at least one side wall extending perpendicularly to the front face, the housing including one or more acoustic ports formed in the at least one side wall, the one or more acoustic ports being positioned at a second edge of the side wall opposite to the first edge; and
a transducer at least partially disposed within the housing, the transducer comprising
a first membrane and a second membrane arranged coaxially about a transducer axis in an opposed relation to each other and configured to move towards and away from the front face along the transducer axis, wherein the transducer axis is parallel to the at least one side wall, and
a driver assembly configured to drive the first and second membranes to produce acoustic energy;
wherein the speaker assembly is configured to direct first acoustic energy from the first membrane to an exterior of the housing via the front face, and to direct second acoustic energy from the second membrane to the exterior of the housing via the one or more acoustic ports.

2. The speaker assembly of claim 1, wherein the rear face does not extend over the second membrane.

3. The speaker assembly of claim 1, wherein the rear face includes a first portion and a second portion, the second portion covering the second membrane and forming a boundary of the one or more acoustic ports, wherein the at least one side wall extends between the front face and the rear face such that the housing forms an enclosure at least partially surrounding the transducer.

4. The speaker assembly of claim 3, wherein the second portion is detachable and secured to the speaker assembly with one or more fasteners.

5. The speaker assembly of claim 3, wherein the second portion includes at least one magnet compartment formed therein, the speaker assembly further comprising one or more magnets disposed within the at least one magnet compartment.

6. The speaker assembly of claim 5, further comprising:
a communication interface coupled to the driver assembly;
at least one processor coupled to the communication interface; and
a tangible computer-readable storage medium coupled to the at least one processor and storing program instructions that when executed by the at least one processor cause the speaker assembly to:
receive, via the communication interface, audio data from an external device magnetically coupled to the speaker assembly via the one or more magnets, and
operate the transducer to produce the acoustic energy based on the audio data.

7. The speaker assembly of claim 5, wherein an exterior surface of the rear face includes a circular indentation surrounding the at least one magnet compartment.

8. The speaker assembly of claim 1, further comprising one or more additional transducers disposed within the housing and configured to output acoustic energy in a first frequency range; and
wherein the transducer is configured to produce the acoustic energy in a second frequency range that is lower in frequency than the first frequency range.

9. The speaker assembly of claim 1, wherein:
the front face is rectangular;
the at least one side wall includes four side walls; and
the one or more acoustic ports includes three acoustic ports respectively formed in three of the four side walls.

10. The speaker assembly of claim 1, wherein the transducer comprises:
a frame having first and second ends, the frame including first and second rims provided at the first and second ends, respectively, wherein the first membrane is mounted to the first rim via a first membrane surround, and wherein the second membrane is mounted to the second rim via a second membrane surround.

11. The speaker assembly of claim 10, wherein the driver assembly comprises a first plurality of motors operatively coupled to the first membrane, and a second plurality of motors operatively coupled to the second membrane, the first and second pluralities of motors being provided on the frame around a periphery of the first and second membranes; and
wherein each motor comprises a magnet and a voice coil.

12. The speaker assembly of claim 1, wherein the housing comprises a scrim cloth positioned over the one or more acoustic ports.

13. A playback device comprising:
a housing defining an interior volume, the housing comprising a front face, a rear face, and a side wall extending between the front face and the rear face;
a transducer disposed in the interior volume of the housing, the transducer comprising a first membrane and a second membrane in an opposed relation to each other and configured to move towards and away from each other, and a driver assembly configured to drive the first and second membranes to produce acoustic energy;
at least one additional transducer disposed in the interior volume of the housing;
a speaker vent in the front face configured to direct first acoustic energy from the first membrane to an exterior of the housing; and
a plurality of acoustic ports in the side wall configured to direct second acoustic energy from the second membrane to the exterior of the housing.

14. The playback device of claim 13, wherein:
the housing is rectangular;
the side wall comprises opposing first and second regions and a third region extending from an edge of the first region to an edge of the second region; and
the plurality of acoustic ports includes a first acoustic port formed in the first region, a second acoustic port formed in the second region, and a third acoustic port formed in the third region.

15. The playback device of claim 13, further comprising:
a communication interface disposed in the interior volume of the housing;
at least one processor disposed in the interior volume of the housing; and
a non-transitory computer-readable storage medium disposed in the interior volume of the housing, coupled to the at least one processor, and storing program instructions executable by the at least the processor to configure the playback device to
receive, via the communication interface, audio content from an external device, and
play back the audio content via the transducer and the at least one additional transducer.

16. The playback device of claim 15, further comprising:
at least one magnet disposed within the rear face; and
at least one sensor configured to detect attachment of the playback device to the external device and/or an orientation of the playback device.

17. The playback device of claim 16, wherein the at least one additional transducer comprises a first additional transducer positioned laterally to one side of the transducer, and a second additional transducer positioned laterally on an opposite side of the transducer such that the transducer is laterally positioned between the first and second additional transducers; and
wherein the program instructions include program instructions executable by the at least one processor to configure the playback device to alter playback of the audio content based on detection of attachment to the external device and/or the orientation of the playback device.

18. The playback device of claim 13, wherein the transducer is configured to produce the acoustic energy in a first frequency range, wherein the at least one additional transducer is configured to output acoustic energy in a second frequency range, and wherein the first frequency range is lower in frequency than the second frequency range.

19. The playback device of claim 13, wherein:
the rear face includes a first portion and a second portion, the second portion covering the second membrane;
an internal surface of the second portion is flat; and
the second portion is detachable and secured to the housing with one or more fasteners.

20. A media playback system comprising:
an external device; and
a speaker assembly configured to magnetically couple to the external device, the speaker assembly comprising
a housing having a front face, a rear face, and a side wall extending between the front face and the rear face, the housing including at least one magnet disposed within a first portion of the rear face to magnetically couple the rear face of the housing to the external device, the housing further including a first speaker vent in the front face and one or more acoustic ports in the side wall, and
a transducer disposed within the housing, the transducer comprising a first membrane and a second membrane in an opposed relation to each other and configured to move towards and away from the front face, and a driver assembly configured to drive the first and second membranes to produce acoustic energy,
a communication interface disposed within the housing,
at least one processor disposed within the housing, and
a non-transitory computer-readable medium disposed within the housing and storing program instructions executable by the at least one processor to cause the speaker assembly to
obtain, via the communication interface, audio content from the external device, and
play back, via the transducer, the audio content received from the external device.
